SEQUENCE LISTING (107 sequences)

SEQ ID NO: 1 - DNA, 52 bp, Artificial Sequence
  APP target site
tagacccccgccacagcagcctctgaagttggacagcaaaaccattgcttca

SEQ ID NO: 2 - DNA, 52 bp, Artificial Sequence
  CD4 target site
tgtctcagctggagctccaggatagtggcacctggacatgcactgtcttgca

SEQ ID NO: 3 - DNA, 52 bp, Artificial Sequence
  TP53 target site
tgtccaatgacctgtcccagaagctgtatgccaccatggagaagcacaagga

SEQ ID NO: 4 - DNA, 52 bp, Artificial Sequence
  TP53 target site
tacaactacatgtgtaacagttcctgcatgggcggcatgaaccggaggccca

SEQ ID NO: 5 - DNA, 52 bp, Artificial Sequence
  CFTR target site
tcggaaggcagcctatgtgagatacttcaatagctcagccttcttcttctca

SEQ ID NO: 6 - DNA, 52 bp, Artificial Sequence
  CFTR target site
tctcttactgggaagaatcatagcttcctatgacccggataacaaggaggaa

SEQ ID NO: 7 - DNA, 52 bp, Artificial Sequence
  DROSHA target site
tgaggaggagattgccaatatgcttcagtgggaggagctggagtggcagaaa

SEQ ID NO: 8 - DNA, 52 bp, Artificial Sequence
  DROSHA target site
tgaaggatacagaaatgactgtgaatcaacccatatcatcaaggagctgata

SEQ ID NO: 9 - DNA, 52 bp, Artificial Sequence
  NFKB1 target site
tatgtatgtgaaggcccatcccatggtggactacctggtgcctctagtgaaa

SEQ ID NO: 10 - DNA, 52 bp, Artificial Sequence
  NFKB1 target site
ttgtcattgctgttgtccctctgctacgttcctattgtcattaaaggtatca

SEQ ID NO: 11 - DNA, 23 bp, Artificial Sequence
  C4BPB target site
aatgaccactacatcctcaaggg

SEQ ID NO: 12 - DNA, 23 bp, Artificial Sequence
  CCR5 target site
tgacatcaattattatacatcgg

SEQ ID NO: 13 - DNA, 23 bp, Artificial Sequence
  DROSHA target site
gattgccaatatgcttcagtggg

SEQ ID NO: 14 - DNA, 23 bp, Artificial Sequence
  CCR5 target site
cctccgctctactcactggtgtt

SEQ ID NO: 15 - DNA, 23 bp, Artificial Sequence
  CCR5 target site
cctgcctccgctctactcactgg

SEQ ID NO: 16 - DNA, 23 bp, Artificial Sequence
  CCR5 target site
gaatcctaaaaactctgcttcgg

SEQ ID NO: 17 - DNA, 23 bp, Artificial Sequence
  CCR5 target site
cctaaaaactctgcttcggtgtc

SEQ ID NO: 18 - DNA, 23 bp, Artificial Sequence
  CCR5 target site
aaatgagaagaagaggcacaggg

SEQ ID NO: 19 - DNA, 23 bp, Artificial Sequence
  AAVS1 target site
ctccctcccaggatcctctctgg

SEQ ID NO: 20 - DNA, 23 bp, Artificial Sequence
  EMX1 target site
gagtccgagcagaagaagaaggg

SEQ ID NO: 21 - DNA, 52 bp, Artificial Sequence
  BRCA1 target site
tccagctgctgctcatactactgatactgctgggtataatgcaatggaagaa

SEQ ID NO: 22 - DNA, 52 bp, Artificial Sequence
  BRCA1 target site
tcctgaacatctaaaagatgaagtttctatcatccaaagtatgggctacaga

SEQ ID NO: 23 - DNA, 52 bp, Artificial Sequence
  CXCR4 target site
tcttcctgcccaccatctactccatcatcttcttaactggcattgtgggcaa

SEQ ID NO: 24 - DNA, 52 bp, Artificial Sequence
  CXCR4 target site
tgggttgatttcagcacctacagtgtacagtcttgtattaagttgttaataa

SEQ ID NO: 25 - DNA, 52 bp, Artificial Sequence
  MCM6 target site
ttagaagtaattttaagggctgaagctgtggaatcagctcaagctggtgaca

SEQ ID NO: 26 - DNA, 52 bp, Artificial Sequence
  MCM6 target site
tggaatcaacttgtatgaaaccttgtcaaaatgtactccacaagtatgtaca

SEQ ID NO: 27 - DNA, 52 bp, Artificial Sequence
  PHF8 target site
tacagaaggcccaaaagaagaaatatatcaagaagaagcctttgctgaagga

SEQ ID NO: 28 - DNA, 52 bp, Artificial Sequence
  PHF8 target site
tacagcctgcttgctccgcctataccacagagcacagcctggacattatgga

SEQ ID NO: 29 - DNA, 52 bp, Artificial Sequence
  SLC18A2 target site
tccagtcatatccgataggtgaagatgaagaatctgaaagtgactgagatga

SEQ ID NO: 30 - DNA, 52 bp, Artificial Sequence
  SLC18A2 target site
tgtataaaacagtgtttccagtgacacaactcatccagaactgtcttagtca

SEQ ID NO: 31 - DNA, 52 bp, Artificial Sequence
  TP53 target site
tgtaccaccatccactacaactacatgtgtaacagttcctgcatgggcggca

SEQ ID NO: 32 - DNA, 52 bp, Artificial Sequence
  TP53 target site
ttgtgagccaccacgtccagctggaagggtcaacatcttttacattctgcaa

SEQ ID NO: 33 - DNA, 23 bp, Artificial Sequence
  APP target site
agaggaggaagaagtggctgagg

SEQ ID NO: 34 - DNA, 23 bp, Artificial Sequence
  APP target site
gccacagcagcctctgaagttgg

SEQ ID NO: 35 - DNA, 23 bp, Artificial Sequence
  BRCA1 target site
gctcatactactgatactgctgg

SEQ ID NO: 36 - DNA, 23 bp, Artificial Sequence
  BRCA1 target site
attgacagcttcaacagaaaggg

SEQ ID NO: 37 - DNA, 23 bp, Artificial Sequence
  MCM6 target site
gctagggacagaagtgtttctgg

SEQ ID NO: 38 - DNA, 23 bp, Artificial Sequence
  MCM6 target site
ctcgtggcctggagcctggctgg

SEQ ID NO: 39 - protein, 21 aa, Artificial Sequence
  peptide tag
GGSGPPKKKRKVYPYDVPDYA

SEQ ID NO: 40 - DNA, 23 bp, Artificial Sequence
  target site
tggggctggataatggagcgtgg

SEQ ID NO: 41 - DNA, 23 bp, Artificial Sequence
  target site
cggtccaacaacgatcccagagg

SEQ ID NO: 42 - DNA, 23 bp, Artificial Sequence
  target site
ctgtgaccacgggacggtgctgg

SEQ ID NO: 43 - DNA, 23 bp, Artificial Sequence
  target site
tccatctcgctcaggtacgaggg

SEQ ID NO: 44 - DNA, 23 bp, Artificial Sequence
  target site
gtcccgtgtcggaaagctgcagg

SEQ ID NO: 45 - DNA, 23 bp, Artificial Sequence
  target site
actacaccgctatgaatgatcgg

SEQ ID NO: 46 - DNA, 23 bp, Artificial Sequence
  target site
cccagaggcccacatacttgggg

SEQ ID NO: 47 - DNA, 23 bp, Artificial Sequence
  target site
acatgccgctatttgagccacgg

SEQ ID NO: 48 - DNA, 23 bp, Artificial Sequence
  target site
ctgaccgacccctagaccgcagg

SEQ ID NO: 49 - DNA, 23 bp, Artificial Sequence
  target site
gcggaaacacgggaccaagtcgg

SEQ ID NO: 50 - DNA, 23 bp, Artificial Sequence
  target site
ccccagtgctcggtttgtcacgg

SEQ ID NO: 51 - DNA, 23 bp, Artificial Sequence
  target site
caaagctgtatttgccctcgggg

SEQ ID NO: 52 - DNA, 23 bp, Artificial Sequence
  target site
gctccaattggatctaccgcggg

SEQ ID NO: 53 - DNA, 23 bp, Artificial Sequence
  target site
tggaccggcgcaggtctccatgg

SEQ ID NO: 54 - DNA, 23 bp, Artificial Sequence
  target site
aggctccgagtagcgcacactgg

SEQ ID NO: 55 - DNA, 23 bp, Artificial Sequence
  target site
ttgtcgaccaggtttctacaagg

SEQ ID NO: 56 - DNA, 23 bp, Artificial Sequence
  target site
aacaccgagatccgggatgtagg

SEQ ID NO: 57 - DNA, 23 bp, Artificial Sequence
  target site
actgcagcgccgaaggggagtgg

SEQ ID NO: 58 - DNA, 23 bp, Artificial Sequence
  target site
tctctcaatacgaattcttgagg

SEQ ID NO: 59 - DNA, 23 bp, Artificial Sequence
  target site
cacctggtatgttcgtatcgggg

SEQ ID NO: 60 - DNA, 23 bp, Artificial Sequence
  target site
cacatgcatccccaacgcagagg

SEQ ID NO: 61 - DNA, 23 bp, Artificial Sequence
  target site
ggctacggaccaagtttatccgg

SEQ ID NO: 62 - DNA, 23 bp, Artificial Sequence
  target site
gcagaatattcggacaaacacgg

SEQ ID NO: 63 - DNA, 23 bp, Artificial Sequence
  target site
cttcaccctttactaccgtcagg

SEQ ID NO: 64 - DNA, 23 bp, Artificial Sequence
  target site
agactgggaattacggttactgg

SEQ ID NO: 65 - DNA, 23 bp, Artificial Sequence
  target site
ggaggccgagcttcgtctactgg

SEQ ID NO: 66 - DNA, 23 bp, Artificial Sequence
  target site
ctctgcatggttgaccgttctgg

SEQ ID NO: 67 - DNA, 23 bp, Artificial Sequence
  target site
cggcaactacacctgcgtcgtgg

SEQ ID NO: 68 - DNA, 23 bp, Artificial Sequence
  target site
aactcccatagtgggtcgagagg

SEQ ID NO: 69 - DNA, 23 bp, Artificial Sequence
  target site
gcagctgtacgccgtggtgtcgg

SEQ ID NO: 70 - DNA, 23 bp, Artificial Sequence
  target site
atctacttgatcgaggttgaggg

SEQ ID NO: 71 - DNA, 23 bp, Artificial Sequence
  target site
ctggtcagtttggcgaagtatgg

SEQ ID NO: 72 - DNA, 23 bp, Artificial Sequence
  target site
gggaccttgcgtacgagaggagg

SEQ ID NO: 73 - DNA, 23 bp, Artificial Sequence
  target site
tgtcgcccgcgttgactctctgg

SEQ ID NO: 74 - DNA, 23 bp, Artificial Sequence
  target site
agctggcgccgaatgtataccgg

SEQ ID NO: 75 - DNA, 23 bp, Artificial Sequence
  target site
tcagtacgccgtttacgtcaagg

SEQ ID NO: 76 - DNA, 23 bp, Artificial Sequence
  target site
gagaattgctctgtcatcgaagg

SEQ ID NO: 77 - DNA, 23 bp, Artificial Sequence
  target site
aagcggactttaaagttcgaggg

SEQ ID NO: 78 - DNA, 23 bp, Artificial Sequence
  target site
agcaacagagcctatcggcatgg

SEQ ID NO: 79 - DNA, 23 bp, Artificial Sequence
  target site
ctggaaagtcgcagaagggctgg

SEQ ID NO: 80 - DNA, 23 bp, Artificial Sequence
  target site
tccaggtttcctgtgatcgtggg

SEQ ID NO: 81 - DNA, 23 bp, Artificial Sequence
  target site
tattctcattcgtttcatccagg

SEQ ID NO: 82 - DNA, 23 bp, Artificial Sequence
  target site
gagccttcgtaggtaaccagtgg

SEQ ID NO: 83 - DNA, 23 bp, Artificial Sequence
  target site
gccacccgtcgacgtcccctggg

SEQ ID NO: 84 - DNA, 23 bp, Artificial Sequence
  target site
gctcaggagcgttgaacttgagg

SEQ ID NO: 85 - DNA, 23 bp, Artificial Sequence
  target site
tggctccaagatactaggcgggg

SEQ ID NO: 86 - DNA, 23 bp, Artificial Sequence
  target site
ctattcccgggaccttttccagg

SEQ ID NO: 87 - DNA, 23 bp, Artificial Sequence
  target site
gcatagctaccaataagcatggg

SEQ ID NO: 88 - DNA, 23 bp, Artificial Sequence
  target site
cagcctaagaccaggaacgccgg

SEQ ID NO: 89 - DNA, 23 bp, Artificial Sequence
  target site
agggaacgtagttatcgtaaggg

SEQ ID NO: 90 - DNA, 23 bp, Artificial Sequence
  target site
ggtcctgaatcgtattcttgggg

SEQ ID NO: 91 - DNA, 23 bp, Artificial Sequence
  target site
tgctgggtgatgcggccggtggg

SEQ ID NO: 92 - DNA, 23 bp, Artificial Sequence
  target site
gtcatcgggccggttatggtggg

SEQ ID NO: 93 - DNA, 23 bp, Artificial Sequence
  target site
gccatagatggtggaccgaaagg

SEQ ID NO: 94 - DNA, 23 bp, Artificial Sequence
  target site
tgaggtgcactaatagagggtgg

SEQ ID NO: 95 - DNA, 23 bp, Artificial Sequence
  target site
tattgccttacatgaattggggg

SEQ ID NO: 96 - DNA, 23 bp, Artificial Sequence
  target site
gtctgacttcgacaacgccaagg

SEQ ID NO: 97 - DNA, 23 bp, Artificial Sequence
  target site
ccacactccgaattcgcccttgg

SEQ ID NO: 98 - DNA, 23 bp, Artificial Sequence
  target site
ggtgatgttgccgaaaaagaagg

SEQ ID NO: 99 - DNA, 23 bp, Artificial Sequence
  target site
cgcctgtgggacgggacacgggg

SEQ ID NO: 100 - DNA, 23 bp, Artificial Sequence
  target site
cagagttcatattctgtccgagg

SEQ ID NO: 101 - DNA, 23 bp, Artificial Sequence
  target site
gcagtaggttgcgcgtagcgagg

SEQ ID NO: 102 - DNA, 23 bp, Artificial Sequence
  target site
gccgtggtactccgtgtgattgg

SEQ ID NO: 103 - DNA, 23 bp, Artificial Sequence
  target site
catcagcgttgatgcagtagagg

SEQ ID NO: 104 - DNA, 23 bp, Artificial Sequence
  target site
gttgtttaccagccacagctggg

SEQ ID NO: 105 - DNA, 23 bp, Artificial Sequence
  target site
gaaccggctgtgtaccgttgtgg

SEQ ID NO: 106 - DNA, 23 bp, Artificial Sequence
  target site s
ggccacactagcgttgctgctgg

SEQ ID NO: 107 - DNA, 23 bp, Artificial Sequence
  target site
tcaggtctgtatttaatggctgg

(19) United States
(12) Patent Application Publication
(10) Pub. No.: US 2017/0076039 A1
(43) Pub. Date: Mar. 16, 2017

(54) A Method of Selecting a Nuclease Target Sequence for Gene Knockout Based on Microhomology

(71) Applicant: INSTITUTE FOR BASIC SCIENCE, Daejeon (KR)

(72) Inventors: Jin Soo Kim, Gwanak-gu, Seoul (KR); Sang Su Bae, Gwanak-gu, Seoul (KR)

(73) Assignee: INSTITUTE FOR BASIC SCIENCE, Daejeon (KR)

(21) Appl. No.: 15/306,270

(22) PCT Filed: Apr. 24, 2015
(86) PCT No.: PCT/KR2015/004132

§ 371 Date: Oct. 24, 2016

Related U.S. Application Data
(60) Provisional application No. 61/983,988, filed on Apr. 24, 2014.

(30) Foreign Application Priority Data
Aug. 6, 2014 (KR) 10-2014-0101133

(51) Int. Cl. G06F 19/24; G06F 19/18

(52) U.S. Cl. CPC G06F 19/24; G06F 19/18

(57) ABSTRACT

The present invention relates to a method of selecting a nuclease target sequence for gene knockout based on microhomology.

### TECHNICAL FIELD

The present invention relates to a method of selecting a nuclease target sequence for gene knockout based on microhomology.

### BACKGROUND ART

Programmable nucleases, which include zinc finger nucleases (ZFNs), transcription-activator-like effector nucleases (TALENs), and RNA-guided engineered nucleases (RGENs) derived from the Type II CRISPR/Cas system, an adaptive immune response in bacteria and archaea, are now widely used for both gene knockout and knock-in in higher eukaryotic cells, animals, and plants. These nucleases induce DNA double-strand breaks (DSBs) at user-defined target sites in the genome, the repair of which via error-prone non-homologous end joining (NHEJ) or error-free homologous recombination (HR) gives rise to targeted mutagenesis and chromosomal rearrangements. Nuclease-mediated gene knockout is achieved preferentially via NHEJ rather than HR because NHEJ is a dominant DSB repair process over HR in higher eukaryotic cells and also because NHEJ does not require homologous donor DNA, fragments of which can be inserted at nuclease on-target and off-target sites. DSB repair by erroneous NHEJ is accompanied by small insertions and deletions (indels) at nuclease target sites, which can cause frameshift mutations in a protein-coding sequence. Inevitably, however, in-frame indels are also generated by this process, reducing the efficacy of nucleases in a population of cells and hampering the isolation of biallelic null clones. A recent study showed that RGENs induced in-frame deletions at frequencies up to 80%, resulting in incomplete gene disruption.

It was reported that TALENs and RGENs produce deletions much more frequently than insertions and that nuclease-induced deletions are often associated with microhomology (Kim, Y. et al., Nature methods, 10:185, 2013), the presence of two identical short (2 to several base) sequences flanking a breakpoint junction: Apparently, microhomology stimulates nuclease-induced deletions via a DSB repair pathway known as microhomology-mediated end joining (MMEJ) (FIG. 1a), as observed in C. elegans, zebrafish, and human cell lines.

### DISCLOSURE

### Technical Problem

In this regard, the present inventors aimed to develop a technology for predicting a target sequence having a high probability of inducing out-of-frame mutations by an engineered nuclease. As a result, the present inventors developed a method and a program for providing useful information for selecting a nuclease target sequence via microhomology-mediated deletion prediction, and confirmed that these may be efficiently used in inducing effective gene disruptions in human cells, animals, etc., thereby completing the present invention.

### Technical Solution

An objective of the present invention is to provide a method of selecting a nuclease target sequence for gene knockout.

Another objective of the present invention is to provide a method of providing information for selecting a sequence having high efficiency of out-of-frame deletion by a nuclease.

Still another objective of the present invention is to provide a computer program capable of performing the method.

Still another objective of the present invention is to provide a computer-readable recording medium in which the program is recorded.

### Advantageous Effects

The method according to the present invention enables to identify or select a target site having a low probability of inducing in-frame mutations thus capable of easily producing mutants with knockout of a particular gene. Therefore, the method of increasing knockout efficiency using technologies such as the engineered nuclease technology can be efficiently used in the field of clinical research on life science.

### DESCRIPTION OF DRAWINGS

FIGS. 1a to 1e show prediction of nuclease-induced deletion patterns that are associated with microhomology. (FIG. 1a) Schematic representation of microhomology-mediated annealing at a nuclease target site. (FIG. 1b) In silico-predicted deletion patterns that result from microhomology-associated DNA repair. Microhomologies are shown in underlined. The equation used for calculating pattern scores is shown below the table. (FIG. 1c) Comparison of the pattern score with the experimentally-determined frequency of the deletion pattern found using the deep sequencing data. Arrows indicate the three most frequent deletion patterns correctly predicted by the scoring system. The Pearson correlation coefficient is shown. (FIG. 1d) Comparison of microhomology scores with the experimentally-determined frequencies of microhomology-associated deletions. The microhomology score is the sum of all the pattern scores assigned to hypothetical deletion patterns at a given target site. (FIG. 1e) Comparison of out-of-frame scores with the frequencies of frameshifting deletions observed in cells transfected with TALENs and RGENs.

FIGS. 2a to 2d show Experimental validation of the scoring system. (FIG. 2a) The distribution of out-of-frame scores associated with potential target sites in the BRCA1 gene. (FIG. 2b) The frequencies of out-of-frame indels determined by deep sequencing at high-score and low-score sites. The dashed lines correspond to the peak value of the Gaussian distribution of out-of-frame scores shown in (FIG. 2a). (FIG. 2c) Correlation of the out-of-frame scores with the frequencies shown in (FIG. 2b). (FIG. 2d) Correlation of the out-of-frame scores with the frequencies of frameshifting indels (left) or deletions (right) induced by 68 RGENs.

FIG. 3 shows analysis of mutations induced by TALENs and RGENs. (a) The average frequencies of mutations induced by 10 TALENs in HEK293T cells and 10 RGENs in K562 cells. (b) Frequencies of deletions and insertions induced by TALENs and RGENs. Nuclease-induced mutations were classified as deletions or insertions relative to the wild-type sequences. Substitutions that may result from PCR or sequencing errors were obtained rarely (<0.1%) and excluded in this analysis. (c) Frequencies of microhomology-associated deletions induced by TALENs and RGENs.

FIGS. 4a to 4c show evaluation of weight factor for deletion length. The weight factor for deletion length was calculated by fitting the deep sequencing data obtained with TALENs (FIG. 4a) and RGENs (FIG. 4b) to a single-exponential function (shown as a line). (FIG. 4c) The average weight factor for TALENs and RGENs.

FIGS. 5a to 5c show source code for assigning a score to a hypothetical deletion pattern associated with microhomology.

FIGS. 6a and 6b show comparison of the pattern score with the experimentally-determined frequency of the pattern using the deep sequencing data. Arrows indicate the most frequent deletion patterns correctly predicted by the scoring system. The Pearson correlation coefficient is shown.

FIG. 7 shows distribution of microhomology scores in the BRCA1 gene. Microhomology scores were assigned to all RGEN target sites in the human BRCA1 gene. The distribution of microhomology scores were fitted to a Gaussian function with a peak value at 4026 and a width of 1916.

FIG. 8 shows high-score and low-score sites. (a) Two RGEN target sites separated by 29 bp in the MCM6 gene. Out-of-frame scores at the two sites are shown in parentheses. (b) The most frequent deletion patterns obtained in cells transfected by the RGEN plasmids. Microhomologies are shown in underlined. The two PAM sequences are highlighted.

FIG. 9 shows comparison of out-of-frame scores with experimental data. (a) Genotype analysis of 81 live-born mice carrying mutations that had been produced via TALENs or RGENs in our previous studies. (b) Correlation of the out-of-frame scores with the frequencies of out-of-frame deletions (Pearson correlation coefficient=0.996).

FIG. 10 shows flow chart for system for selecting a target having high efficiency of gene knockout.

### BEST MODE

In one aspect, the present invention provides a method of selecting a nuclease target sequence for gene knockout.

The method according to the present invention may be used as a target-selecting system capable of pre-estimating the frequency of microhomology-associated deletion, may calculate the out-of-frame score of an in silico nuclease target site, and may help selecting an appropriate target site to enable gene knockout in cultured cells, plants, or animals using a scoring system. Therefore, the method may be used for predicting a frequency of out-of-frame deletions of a nuclease target sequence.

In particular, the present invention provides a method of selecting a nuclease target sequence for gene knockout, which includes:
(a) providing a nuclease target sequence candidate;
(b) collecting information of microhomology present in the nuclease target sequence candidate; and
(c) predicting frequency of microhomology-associated out-of-frame deletion of the nuclease target sequence candidate based on the information of microhomology collected in step (b).

Further, the method further comprises a step of comparing the frequency of microhomology-associated out-of-frame deletion predicted in step (c) with frequency of microhomology-associated out-of-frame deletion of other nuclease target sequence candidate. Through this step, the nuclease target sequence having high efficiency of out-of-deletion frame deletion can be selected among the nuclease target sequence candidates.

Further, the information of microhomology may comprise a size of microhomology sequence, a distance between two microhomology sequences, and sequence information of the microhomology sequence, but is not limited thereto.

The nuclease target sequence candidate may include any sequence as long as it is a sequence in which deletion may be induced by microhomology. In particular, the sequence may be originated from human cells, zebrafish, C. elengans, etc., but is not limited thereto. Further, the sequence may be a sequence of mammalian cells, insect cells, plant cells, fish cells, or etc, but is not limited thereto.

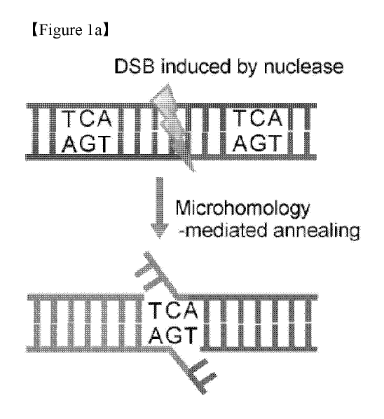

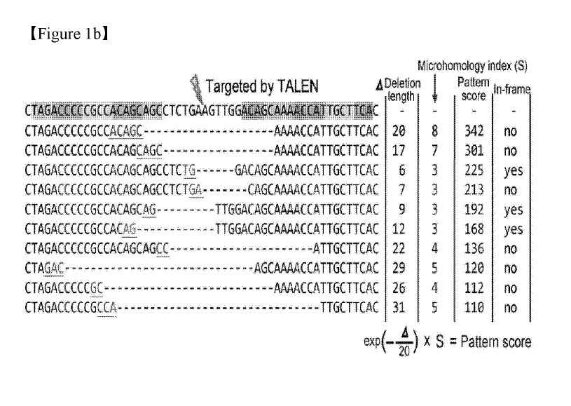

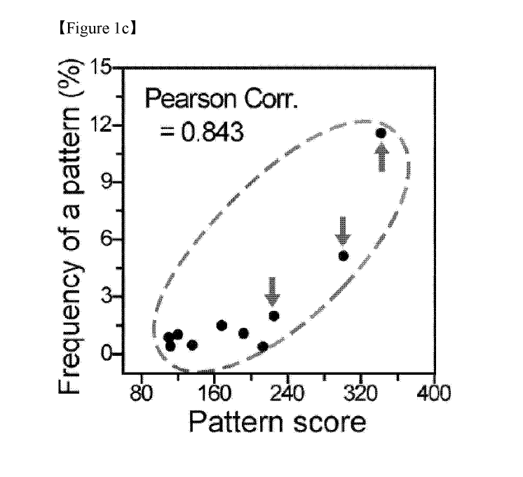

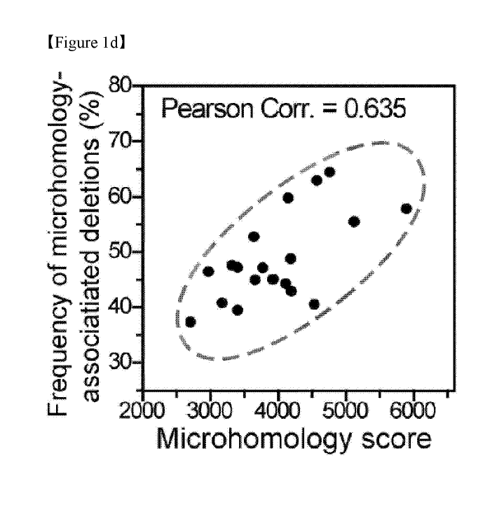

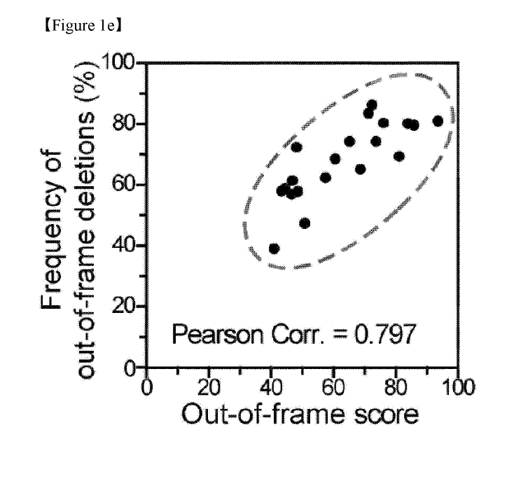

In the present invention, the microhomology sequence present in the target sequence refers to a sequence of at least 2 bp having 100% identity with a sequence present in other region of the target sequence. In detail, the microhomogy sequences refer to identical sequences of at least 2 bp flaking a position expected to be cleaved by a nuclease, but not limited thereto. For example, the microhomology sequence in the present invention may have a length of at least 2 bp, 3 bp, 4 bp, 5 bp, 6 bp, 7 bp, or 8 bp, but is not limited thereto. The length of the microhomology sequence may vary depending on a given nuclease target sequence, and is preferably at least 2 bp. Further, the length of the microhomology sequence is preferably shorter than the length from 5′ or 3′ end of the target sequence to a position expected to be cleaved by a nuclease of the nuclease target sequence. If microhomology sequences are present in both sides of a position cleaved by a nuclease, nuclease-induced deletion may be induced by microhomology-mediated annealing (FIG. 1a).

The nuclease target sequence candidate or nuclease target sequence according to the present invention may have an identical sequence length in both directions with respect to a position expected to be cleaved by a nuclease, but is not limited thereto.

Bases which constitute the target sequence according to the present invention may be selected from the group consisting of A, T, G, and C, but are not limited thereto as long as they are bases which constitute the target sequence.

The position expected to be cleaved by a nuclease according to the present invention refers to a position where the covalently bonded backbone of the nucleotide molecules is expected to be disrupted by a nuclease.

The target sequence may be located in a gene regulatory region or a gene region, but is not limited thereto. The target sequence may be present within 10 kb, 5 kb, 3 kb, or 1 kb, or 500 bp, 300 bp, or 200 bp from the transcription start site of a gene, for example, upstream or downstream of the start site, but is not particularly limited as long as it is a target sequence for a nuclease.

Meanwhile, the gene regulatory region according to the present invention may be selected from promoters, transcription enhancers, 5′ non-coding regions, 3′ non-coding regions, virus packaging sequences, and selectable markers, but is not limited thereto. Further, the gene region according to the present invention may be an exon or an intron, but is not limited thereto.

The nuclease according to the present invention may be selected from the group consisting of zinc finger nucleases (ZFNs), transcription-activator-like effector nucleases (TALENs), and RNA-guided engineered nucleases (RGENs), but is not limited thereto.

ZFN may include a DNA-cleavage domain and a Zinc finger DNA-binding domain, and particularly, an integration of the two domains, which may be connected by a linker. Further, the zinc finger DNA-binding domain may be modified so that it can bind to a desired DNA sequence.

Further, TALEN may include a DNA-cleavage domain and transcription activator-like effectors (TALE) DNA-binding domain, and particularly an integration of the two domains, which may be connected by a linker. Further, TALE may be modified so that it binds to a desired DNA sequence.

RGEN refers to a nuclease containing a target DNA-specific guide RNA and Cas protein as components. The term “guide RNA” refers an RNA specific to a target DNA, which binds to Cas protein, thereby guiding the Cas protein to the target DNA.

Further, the guide RNA may be composed of two RNAs such as CRISPR RNA (crRNA) and trans-activating crRNA (tracrRNA), or may be a single-chain RNA (sgRNA) produced by the integration of main parts of crRNA and tracrRNA.

The guide RNA may be a dual RNA including crRNA and tracrRNA, and crRNA may bind to a target DNA.

Examples of the nuclease are not limited thereto, but may include any nuclease capable of inducing microhomology-associated deletion reflecting the objectives of the present invention, without limitations.

Further, in order to predict the frequency of microhomology-associated out-of-frame deletion of the nuclease target sequence candidate, step (c) may comprise calculating a pattern score, which is a score assigned to an expected deletion pattern of each of microhomologies present in the given nuclease target sequence candidate; and calculating (i) a microhomology score, which is a sum of the pattern scores of all microhomologies in the given nuclease target sequence candidate and (ii) a out-of-frame score, which is a ratio of a score which is a sum of the pattern scores of microhomologies associated with out-of-frame deletion to the microhomology score, based on the calculated pattern score.

The method according to the present invention may comprise the following steps, but it not limited thereto:

i) providing a nuclease target sequence candidate;

ii) examining, in the given nuclease target sequence, whether two identical sequences of at least 2 bp flanking a position expected to be cleaved by a nuclease are present in the target sequence to identify the presence of microhomology;

iii) obtaining information of microhomology, when the microhomology is present in the target sequence, and repeating steps ii) and iii) one or more times;

iv) calculating a pattern score, which is a score assigned to an expected deletion pattern of each of microhomologies present in the given nuclease target sequence candidate; and

v) calculating (i) a microhomology score, which is a sum of the pattern scores of all microhomologies in the given nuclease target sequence candidate and (ii) a out-of-frame score, which is a ratio of a score which is a sum of the pattern scores of microhomologies associated with out-of-frame deletion to the microhomology score.

Step ii) is a step of obtaining information of microhomology, e.g., a distance between 5′ positions of the microhomology sequences or a distance between 3′ positions of the microhomology sequences, and sequence information of the microhomology sequence, when the microhomology is present in the target sequence. Further, step iii) may further comprise a step of repeating step ii) and iii) one or more times to obtain information on all microhomologies.

In particular, step iii) may be for obtaining information about a deletion length when nuclease-induced deletion is induced by MMEJ, and microhomology sequence, location, etc.

All microhomogy patterns present in the given nuclease target sequence can be obtained via step iii).

Step iv) refers to calculating a pattern score based on the information obtained from step

In an embodiment, the present invention confirmed that microhomology-associated deletion depends on the size and deletion length of microhomology. In particular, it was confirmed that as the size of microhomology increases, the frequency of deletion increase, while as the deletion length increases, the frequency of deletion decreases. In this regard, an equation for scoring a hypothetical deletion pattern (herein, also referred to as “pattern score”) of a given nuclease target sequence was induced based on the results.

In particular, a pattern score may be calculated by the following Equation 1.

Pattern score=SXexp(−Δ/W_{length}), [Equation 1]

wherein:

S is a microhomology index that corresponds to the size and base pairing energy of the microhomology sequence;

Δ is a distance between 5′ positions of the microhomology sequences or a distance between 3′ positions of the microhomology sequences (deletion length); and

W_{length} is a weight factor on a distance between the microhomology sequences.

More particularly, S is an index which corresponds to the size of a microhomology sequence and the base pairing energy which constitutes the same, and for example, may be calculated using Equation 4.

Microhomology index=(number of G and C in a microhomology sequence)*2+(number of A and T bases in a microhomology sequence). [Equation 4]

Considering that G:C pairs are more stable than A:T pairs, +2 was assigned for the number of GC, and +1 was assigned for the number of AT, but are not limited thereto. It may be calculated by various methods which put more weight on the number of GC.

Further, in the equation,

W_{length} is a weight factor on a distance between the two sequence fragments, and may be 20 for example. However it is not limited thereto.

Furthermore, in one embodiment, the present invention may perform calculating a pattern score by classifying step iv) into either when a deletion length is a multiple of 3 or when it is not a multiple of 3, but is not limited thereto.

Here, when a distance between sequence fragments, thus a deletion length, is a multiple of 3, it may be determined that an in-frame deletion will be induced. On the other hand, when the deletion length is not a multiple of 3, it may be determined that an out-of-frame deletion will be induced.

Further, prior to performing step iv), eliminating of overlapping information obtained from step iii) may be included, but is not limited thereto.

Step v) of the method is a step of calculating a microhomology score, an out-of-frame score, or both based on the pattern score from iv). Further, more particularly, the microhomology score and out-of-frame score may be calculated by the following Equations 2 and 3, respectively.

Microhomology score=Σ pattern score, [Equation 2]

wherein the microhomology score is a sum of pattern scores of the obtained all microhomologies;

Out-of-frame score=Σ pattern score of out-of-frame deletion/microhomology score(Σ pattern score), [Equation 3]

wherein Σ pattern score of out-of-frame deletion is a sum of pattern scores of relevant microhomologies whose a deletion length is not a multiple of 3.

Based on the microhomology score and the out-of-frame score calculated in the step above, the frequency of microhomology-associated deletion and frame shifting mutation regarding a nuclease target sequence may be predicted.

The method according to the present invention may be implemented as a computer program, and be used to easily select a target having high efficiency of gene knockout. Computer programming languages capable of implementing the method according to the present invention are Python, C, C++, Java, Fortran, Visual basic, etc., but are not limited thereto. Each of the programs may be saved in a compact disc read only memory (CD-ROM), a hard disk, a magnetic diskette, or a similar recording medium tools, etc., and may be connected to intra- or internetwork systems. For example, the computer system may search the nucleotide sequences of a target gene or a regulatory region thereof by connecting to a sequence data base such as GenBank (http://www.ncbi.nlm.nih.gov/nucleotide) using HTTP, HTTPS, or XML protocols.

The method according to the present invention may be used to help selecting an appropriate target site for knockout in cultured cells, plants, and animals by effectively predicting the frequency of microhomology-associated deletion of a nuclease target sequence. Further, the method may significantly increase efficiency not only in gene knockout cell clones and animals such as livestock, but also in nuclease-mediated genes or cellular therapies.

In another aspect, the present invention provides a method of providing information for selecting a sequence having a high efficiency of out-of-frame deletion by a nuclease.

In particular, it provides a method of providing information for selecting a sequence having high efficiency of out-of-frame deletion by a nuclease, including:

(a) providing a nuclease target sequence candidate;

(b) collecting information of microhomology present in the nuclease target sequence candidate; and

(c) predicting frequency of microhomology-associated out-of-frame deletion of the nuclease target sequence candidate based on the information of microhomology collected in step (b).

Steps (a) to (c) and each term are the same as described above.

In another aspect, the present invention provides a computer program performing the steps of the method according to the present invention.

The method, each step, and the computer program are the same as previously described above.

In another aspect, the present invention provides a computer-readable recording medium in which the program is recorded.

The program, the recording medium, etc., are the same as previously described above.

### MODE FOR INVENTION

Hereinafter, the present invention will be described in more detail with reference to Examples. It is to be understood, however, that these examples are for illustrative purposes only and are not intended to limit the scope of the present invention.

### Example 1

### Materials & Methods

(1) Cell Culture and Transfection

K562 (ATCC, CCL-243) cells were grown in RPMI-1640 with 10% FBS and a penicillin/streptomycin mix (100 units/mL and 100 mg/mL, respectively). To induce mutations in human cells using RGENs, 2×10⁶ K562 cells were transfected with 20 μg of Cas9-encoding plasmid using Amaxa SF Cell Line 4D-Nucleofector Kit (Lonza) according to the manufacturer's protocol. After 24 h, 60 mg and 120 mg of in vitro transcribed crRNA and tracrRNA, respectively, were transfected into 1×10⁶ K562 cells. Genomic DNA was isolated at 48 h post-transfection. HEK293T/17 (ATCC, CRL-11268) and HeLa (ATCC, CCL-2) cells were maintained in Dulbecco's modified Eagle's medium (DMEM) supplemented with 100 units/mL penicillin, 100 μg/mL streptomycin, 0.1 mM nonessential amino acids, and 10% fetal bovine serum (FBS). To induce mutations in HEK 293T cells using TALENs, 2×10⁵ HEK293T cells were transfected with TALEN-encoding plasmids (500 ng) using lipofectamine 2000 (Invitrogen, Carlsbad, Calif.) according to the manufacturer s protocol. Genomic DNA was isolated at 72 h post-transfection. 1.6×10⁴ HeLa cells were transfected with Cas9-encoding plasmid (0.1 μg) and sgRNA expression plasmid (0.1 μg) using Lipofectamine 2000 (Invitrogen) according to the manufacturer's protocol. Cells were collected 72 h after transfection and lysed with cell lysis buffer (0.005% SDS containing Proteinase K from Tritirachium album (1:50; Sigma-Aldrich)).

(2) Construction of TALEN-Encoding Plasmids

TALENs were designed to target sites shown in Tables 1 and 2. TALEN-encoding plasmids were assembled using the one-step Golden-Gate cloning system that we described previously.

TABLE 1

| Nuclease | | | | |
|---|---|---|---|---|
| (cell) | | | | SEQ ID |
| type) | Gene | Name | Target site (5′-3′)* | NO |
| TALEN | APP | APP_1 | TAGACCCCCGCCACAGCAGC ctctgaagttgg | 1 |
| (HEK293T) | | | ACAGCAAAACCATTGCTTCA | |
| | CD4 | CD_4 | TGTCTCAGCTGGAGCTCCAG gatagtggcacc | 2 |
| | | | TGGACATGCACTGTCTTGCA | |
| | CREBBP | CREB_1 | TGTCCAATGACCTGTCCCAG aagctgtatgcc | 3 |
| | | | ACCATGGAGAAGCACAAGGA | |
| | TP53 | TP53_1 | TACAACTACATGTGTAACAG ttcctgcatggg | 4 |
| | | | CGGCATGAACCGGAGGCCCA | |
| | CFTR | CFTR_1 | TCGGAAGGCAGCCTATGTGA gatacttcaata | 5 |
| | | | GCTCAGCCTTCTTCTTCTCA | |
| | CFTR | CFTR_2 | TCTCTTACTGGGAAGAATCA tagcttcctatg | 6 |
| | | | ACCCGGATAACAAGGAGGAA | |
| | DROSHA | DROS_1 | TGAGGAGGAGATTGCCAATA tgcttcagtggg | 7 |
| | | | AGGAGCTGGAGTGGCAGAAa | |
| | DROSHA | DROS_2 | TGAAGGATACAGAAATGACT gtgaatcaaccc | 8 |
| | | | ATATCATCAAGGAGCTGATA | |
| | NFKB1 | NFKB_1 | TATGTATGTGAAGGCCCATC ccatggtggact | 9 |
| | | | ACCTGGTGCCTCTAGTGAAA | |
| | NFKB1 | NFKB_2 | TTGTCATTGCTGTTGTCCCT ctgctacgttcc | 10 |
| | | | TATTGTCATTAAAGGTATCA | |
| RGEN | C4BPB | C4BP_1 | AATGACCACTACATCCTCAAGGG | 11 |
| (K562) | CCR5 | CCR5_1 | TGACATCAATTATTATACATCGG | 12 |
| | DROSHA | DROS_1 | GATTGCCAATATGCTTCAGTGGG | 13 |
| | CCR5 | CCR5_2 | CCTCCGCTCTACTCACTGGTGTT | 14 |
| | CCR5 | CCR5_3 | CCTGCCTCCGCTCTACTCACTGG | 15 |
| | CCR5 | CCR5_4 | GAATCCTAAAAACTCTGCTTCGG | 16 |
| | CCR5 | CCR5_5 | CCTAAAAACTCTGCTTCGGTGTC | 17 |
| | CCR5 | CCR5_6 | AAATGAGAAGAAGAGGCACAGGG | 18 |
| | AAVS1 | AAVS1_1 | CTCCCTCCCAGGATCCTCTCTGG | 19 |
| | EMX1 | EMX1 | GAGTCCGAGCAGAAGAAGAAGGG | 20 |

*A TALEN site consists of the left-half site (upper-case letters), spacer (lower-case letters), and the right half site (upper-case letters. PAM sequences are shown in underlined.

TABLE 2

| Nuclease | | | | |
|---|---|---|---|---|
| (cell) | | | | SEQ ID |
| type) | Gene | Name | Target site (5′-3′)* | NO |
| TALEN | BRCA1 | BRCA1_1 | TCCAGCTGCTGCTCATACTA ctgatactgctg | 21 |
| (HEK293T) | | | GGTATAATGCAATGGAAGAA | |
| | BRCA1 | BRCA1_h | TCCTGAACATCTAAAAGATG aagtttctatca | 22 |
| | | | TCCAAAGTATGGGCTACAGA | |
| | CXCR4 | CXCR4_1 | TCTTCCTGCCCACCATCTAC tccatcatcttc | 23 |
| | | | TTAACTGGCATTGTGGGCAA | |
| | CXCR4 | CXCR4_h | TGGGTTGATTTCAGCACCTA cagtgtacagtc | 24 |
| | | | TTGTATTAAGTTGTTAATAA | |
| | MCM6 | MCM6_1 | TTAGAAGTAATTTTAAGGGC tgaagctgtgga | 25 |
| | | | ATCAGCTCAAGCTGGTGACA | |
| | MCM6 | MCM6_h | TGGAATCAACTGGTATGAAA ccttgtcaaaat | 26 |
| | | | GTACTCCACAAGTATGTACA | |
| | PHF8 | PHF8_1 | TACAGAAGGCCCAAAAGAAG aaatatatcaag | 27 |
| | | | AAGAAGCCTTTGCTGAAGGA | |
| | PHF8 | PHF8_h | TACAGCCTGCTTGCTCCGCC tataccacagag | 28 |
| | | | CACAGCCTGGACATTATGGA | |
| | SLC18A2 | SLC18_1 | TCCAGTCATATCCGATAGGT gaagatgaagaa | 29 |
| | | | TCTGAAAGTGACTGAGATGA | |
| | SLC18A2 | SLC18_h | TGTATAAAACAGTGTTTCCA gtgacacaactc | 30 |
| | | | ATCCAGAACTGTCTTAGTCA | |
| | TP53 | TP53_1 | TGTACCACCATCCACTACAA ctacatgtgtaa | 31 |
| | | | CAGTTCCTGCATGGGCGGCA | |
| | TP53 | TP53_h | TTGTGAGCCACCACGTCCAG ctggaagggtca | 32 |
| | | | ACATCTTTTACATTCTGCAA | |
| RGEN | APP | APP_1 | AGAGGAGGAAGAAGTGGCTGAGG | 33 |
| (K562) | APP | APP_h | GCCACAGCAGCCTCTGAAGTTGG | 34 |
| | BRCA1 | BRCA1_1 | GCTCATACTACTGATACTGCTGG | 35 |
| | BRCA1 | BRCA1_h | ATTGACAGCTTCAACAGAAAGGG | 36 |
| | MCM6 | MCM6_1 | GCTAGGGACAGAAGTGTTTCTGG | 37 |
| | MCM6 | MCM6_h | CTCGTGGCCTGGAGCCTGGCTGG | 38 |

*A TALEN site consists of the left-half site (upper-case letters), spacer (lower-case letters), and the right half site (upper-case letters. PAM sequences are shown in underlined.

(3) Construction of Cas9-Encoding Plasmids.

The Cas9-encoding plasmid and sgRNA-encoding plasmids were constructed. The Cas9 protein is expressed under the control of the CMV promoter and fused to a peptide tag (NH₃-GGSGPPKKKRKVYPYDVPDYA-COOH, SEQ ID NO: 39) containing the HA epitope and a nuclear localization signal (NLS) at the C-terminus.

(4) RNA Preparation

RNAs used in K562 cells were in vitro transcribed through run-off reactions by T7 RNA polymerase using a MEGAshortscript T7 kit (Ambion) according to the manufacturer's manual. Templates for sgRNA or crRNA were generated by annealing and extension of two complementary oligonuceotides (Tables 1 or 2). Transcribed RNA was purified by phenol:chloroform extraction, chloroform extraction, and ethanol precipitation. Purified RNA was quantified by spectrometry.

(5) Targeted Deep Sequencing

Genomic DNA segments that encompass the nuclease target sites were amplified using Phusion polymerase (New England Biolabs). Equal amounts of the PCR amplicons were subjected to paired-end read sequencing using Illumina MiSeq at Bio-Medical Science Co. (South Korea). Rare sequence reads that constituted less than 0.005% of the total reads were excluded. Indels located around the RGEN cleavage site (3 bp upstream of the PAM) and around the TALEN target site (spacer) were considered to be mutations induced by RGENs and TALENs, respectively.

### Example 2

### Determination of Mutant Sequences Induced by TALENs and RGENs in Human Cells

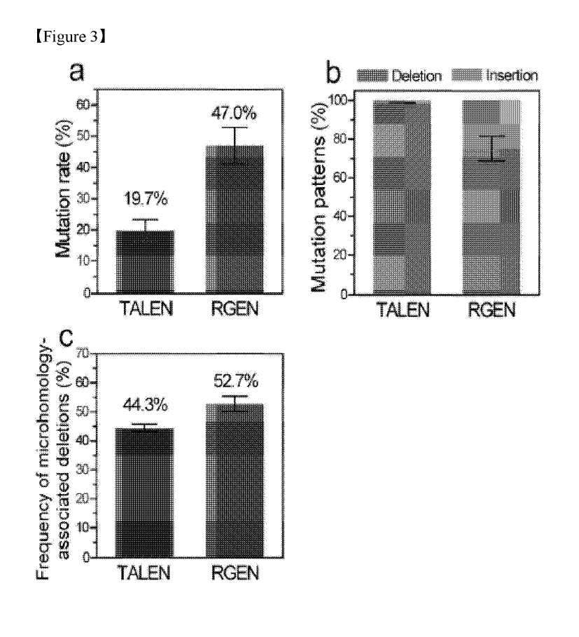

The mutant sequences induced by 10 TALENs and 10 RGENs in human cells using deep sequencing were determined. TALENs and RGENs induced mutations at frequencies of 19.7±3.6% (mean±s.e.m) in HEK293T cells and 47.0±5.9% in K562 cells, respectively (FIG. 3, Tables 1 and 3).

Analysis was focused on deletions and excluded insertions because deletions are much more prevalent than are insertions (98.7% vs. 1.3% for TALENs and 75.1% vs. 24.9% for RGENs) and because microhomology is irrelevant to insertions. In aggregate, deletions were associated with microhomology at a frequency of 44.3% for TALENs and 52.7% for RGENs (FIG. 3, Table 3). Thus, 43.7% (=0.987×0.443) and 39.6% (=0.751×0.527) of all the indels induced by TALENs and RGENs, respectively, were associated with microhomology. At a given nuclease target site, these microhomology-associated deletions can be predicted. In an extreme case, all or none of these deletions can cause frameshift in a protein-coding gene. In contrast, one third of microhomology-independent indels result in in-frame mutations. Assuming that ˜60% of indels are microhomology-independent on average, the fraction of in-frame mutations at a given site can range from 20% (=60%/3+0%) to 60% (=60%/3+40%), a three-fold difference between the two extreme cases. Because most eukaryotic cells are diploid rather than haploid, the fraction of null cells carrying two out-of-frame mutations can range from 16% (=0.40×0.40) to 64% (=0.80×0.80), depending on the choice of target sites.

TABLE 3

| | | | | | | Frequency | Frequency | Frequency | | |
|---|---|---|---|---|---|---|---|---|---|---|
| | | | | | | of | of | of | | |
| | | | Number | | | out-of- | out-of- | microhomology- | | |
| Nuclease | | | of | | | frame | frame | associated | Micro- | Out-of- |
| (cell | | | sequence | | | deletions | indels | deletions | homology | frame |
| type) | Gene | Name | reads | Insertion | Deletion | (%) | (%) | (%) | score* | score^{b} |
| TALEN | APP | APP_1 | 58822 | 148 | 24260 | 74.18796373 | 74.22976073 | 45.08326 | 3930 | 73.61323155 |
| (HEK293T) | CD4 | CD4_1 | 130890 | 221 | 15863 | 79.56250394 | 79.66923651 | 45.04633 | 3915 | 85.84929757 |
| | CREBBP | CREB_1 | 146455 | 524 | 46455 | 72.3065332 | 72.41959173 | 48.77021 | 4184 | 48.11185468 |
| | TP53 | TP53_1 | 104451 | 216 | 13619 | 58.7561495 | 59.02421395 | 37.33461 | 2704 | 44.41568047 |
| | CFTR | CFTR_1 | 133089 | 181 | 11835 | 57.82847486 | 58.21553301 | 40.79425 | 3171 | 48.53358562 |
| | CFTR | CFTR_2 | 122477 | 90 | 9239 | 80.14936681 | 80.26583771 | 47.2129 | 3399 | 83.81877023 |
| | DROSHA | DROS_1 | 218200 | 360 | 34204 | 61.34370249 | 61.23423215 | 42.91603 | 4195 | 46.79380215 |
| | DROSHA | DROS_2 | 240203 | 1455 | 74503 | 69.29251171 | 69.37649754 | 39.50177 | 3400 | 81.05882353 |
| | NFKB1 | NFKB_1 | 107680 | 189 | 14017 | 57.95105943 | 57.90511052 | 44.29835 | 4111 | 43.29846753 |
| | NFKB1 | NFKB_2 | 235082 | 748 | 47387 | 80.92514825 | 80.69595928 | 52.7383 | 3642 | 93.49258649 |
| RGEN | C4BPB | C4BP_1 | 47856 | 21247 | 11768 | 38.978586 | 76.08662729 | 46.46924 | 2969 | 40.9902324 |
| (K562) | CCR5 | CCR5_1 | 200645 | 10727 | 94967 | 83.49216043 | 83.75877533 | 47.60201 | 3316 | 71.26055489 |
| | DROSHA | DROS_1 | 251509 | 15723 | 106834 | 56.85549544 | 60.24217303 | 40.52596 | 4530 | 46.55629139 |
| | CCR5 | CCR5_2 | 76347 | 1723 | 26406 | 74.16496251 | 75.49148566 | 47.13929 | 3772 | 65.16436904 |
| | CCR5 | CCR5_3 | 73367 | 2511 | 10001 | 62.34376562 | 69.46131714 | 55.49345 | 5118 | 57.44431419 |
| | CCR5 | CCR5_4 | 69780 | 1325 | 17745 | 53.08312201 | 67.29417934 | 59.77289 | 4148 | 68.63548698 |
| | CCR5 | CCR5_5 | 99571 | 3256 | 29392 | 80.3041644 | 82.11529037 | 62.9491 | 4569 | 76.01225651 |
| | CCR5 | CCR5_6 | 106450 | 22712 | 25837 | 68.4754422 | 83.03363612 | 44.9402 | 3660 | 60.51912568 |
| | AAVS1 | AAVS1_1 | 43249 | 7812 | 18964 | 86.24762708 | 93.29997012 | 37.83959 | 5894 | 72.34476 |
| | EMX1 | EMX1 | 52945 | 16745 | 22358 | 47.30072622 | 69.47453476 | 64.47283 | 4756 | 50.75694 |

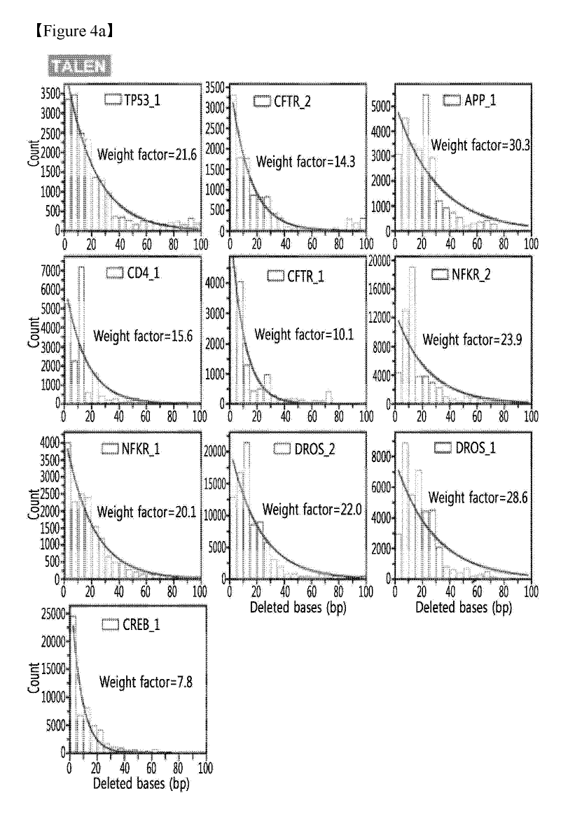

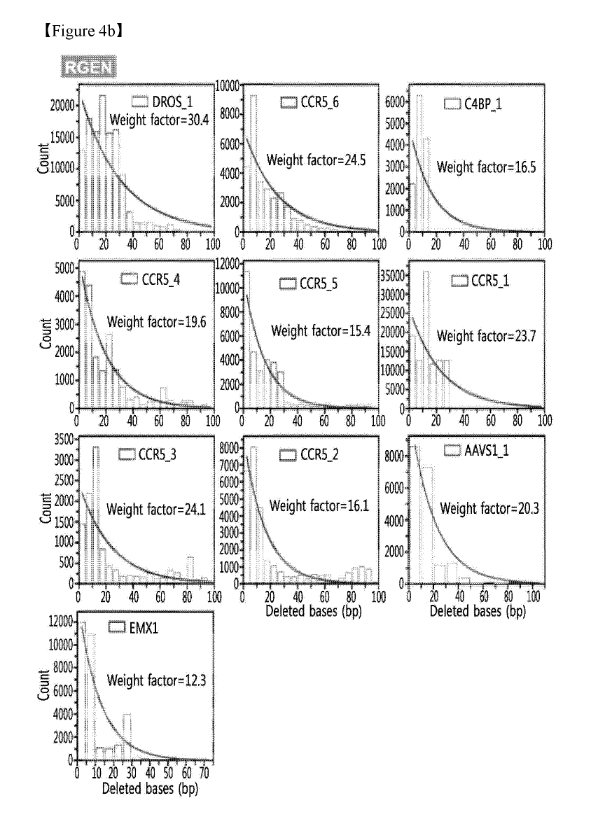

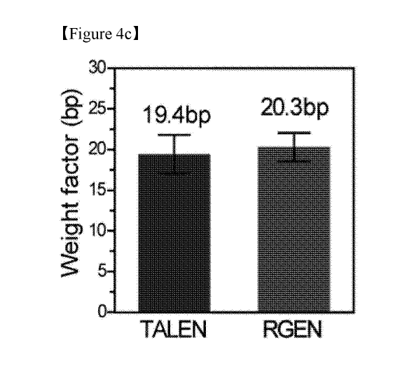

A careful analysis of indel sequences also revealed that the frequency of microhomology-associated deletions depends on both the size of the microhomology and the length of the deletions. Thus, as the microhomology size increased, the deletion frequency also increased. In addition, as the length of deletions increased, the deletion frequency decreased exponentially (FIG. 4). For example, the two most frequent deletions induced by a TALEN pair specific to the human APP gene were associated with 5- and 4-nucleotide sequences separated by 20 and 17 bp, respectively, near the target site (FIG. 1b).

### Example 3

### Formula to Predict Microhology-Associated Deletions

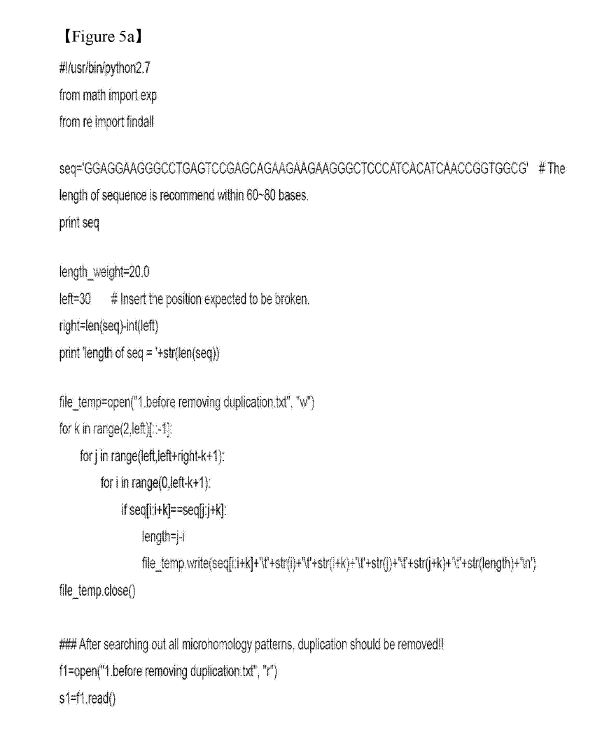

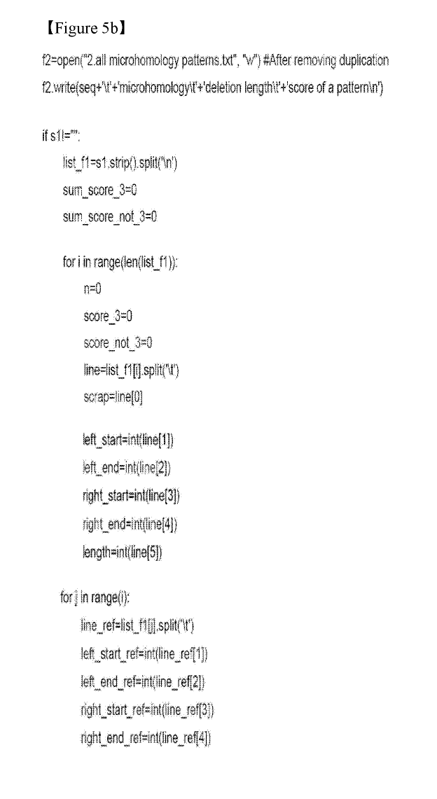

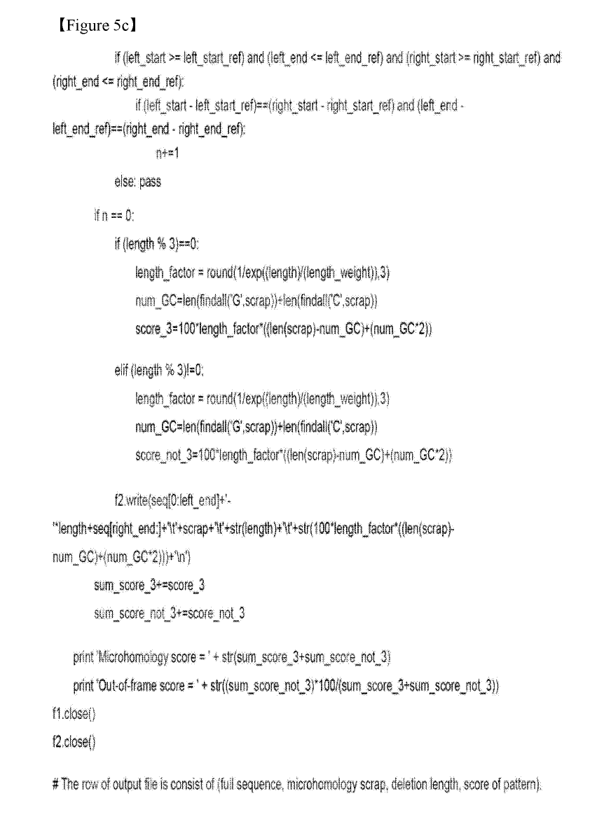

Based on these observations, a simple formula to predict microhology-associated deletions was developed. First, deletion patterns at a given nuclease target site that are associated with microhomology of at least 2 bases in silico were predicted and then a score was assigned to each hypothetical deletion pattern using a computer program written in Python (FIGS. 5a to 5c), according to the following equation 1 that accounts for both the size of microhomology and the deletion length (FIG. 1b).

A pattern score=SXexp(−Δ/20), [Equation 5]

where S is the microhomology index that corresponds to the size of microhomology and base pairing energy and

Δ is the deletion length in base pairs (bp).

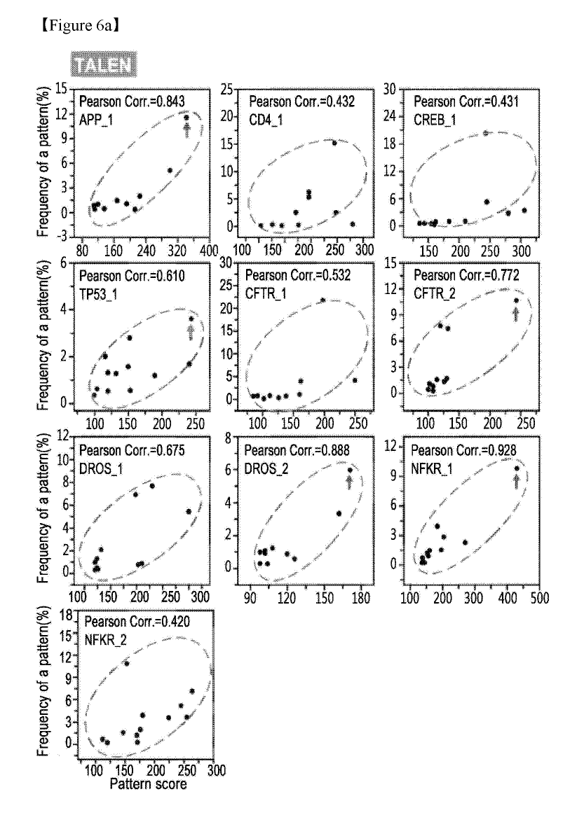

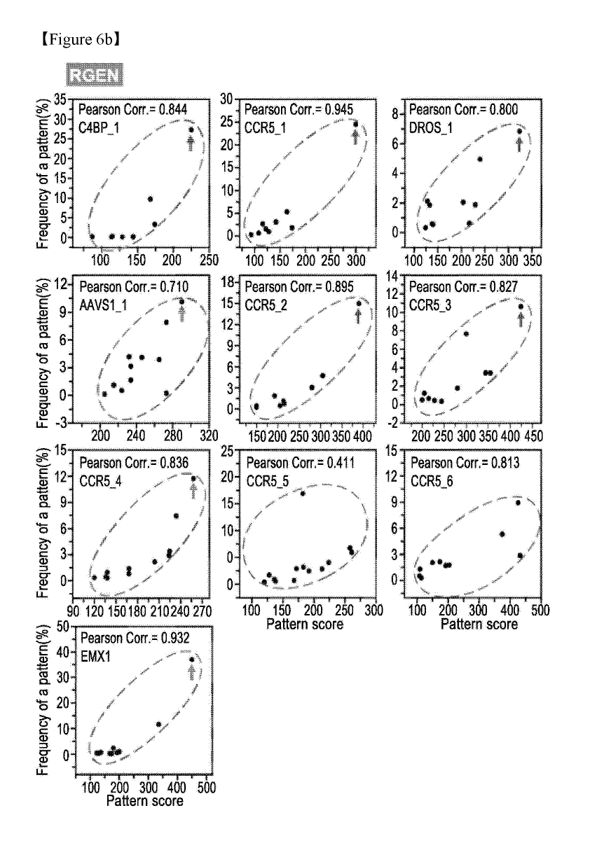

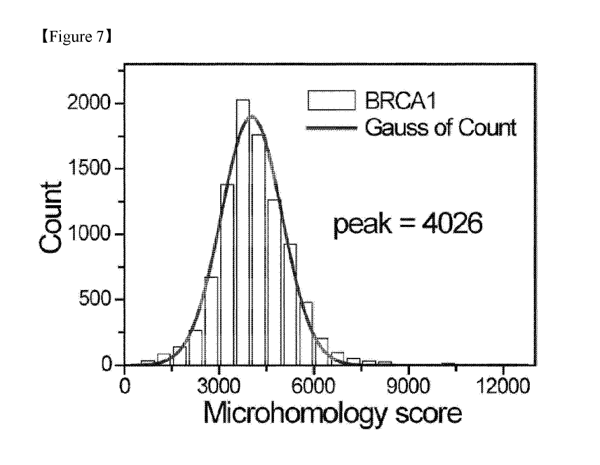

Because G:C base pairs are more stable than are A:T pairs, each A:T pair and each G:C pair in the microhomology sequence were arbitrarily assigned to +1 and +2, respectively, to obtain the microhomology index. This simple formula accurately predicted the three most frequent deletion patterns at the TALEN site (FIG. 1c). The program was used to assign scores to the other 19 sites. The program accurately predicted the most frequent deletion pattern at 5 TALEN sites and 8 RGEN sites (FIGS. 6a and 6b). Overall, the scores correlated well with the deep sequencing data: The Pearson correlation coefficient ranged from 0.411 to 0.945 at the 20 sites with a mean value of 0.727.

### Example 4

### Evaluation of Utility of Scoring System

To choose nuclease target sites that are prone to forming microhomology-mediated deletions and out-of-frame mutations, two scores were assigned to each target site. A microhomology score is the sum of all the scores assigned to hypothetical deletion patterns at a given site: Σ pattern score. An out-of-frame score assigned to each target site is calculated by the following equation 2:

Out-of-frame score=Σ pattern score of an out-of-frame deletion/Σ pattern score [Equation 3]

The distance between the target sites was ±30 bp. Then, the predicted scores were compared with the experimental data at the 20 sites. Both the microhomology scores and the out-of-frame scores were statistically significant predictors of the frequencies of microhomology-associated deletions and frame shifting mutations, respectively (Pearson coefficient=0.635 and 0.797, respectively) (FIGS. 1d and e). These results suggest that one can use the scoring system to choose sites appropriate for targeted gene disruption.

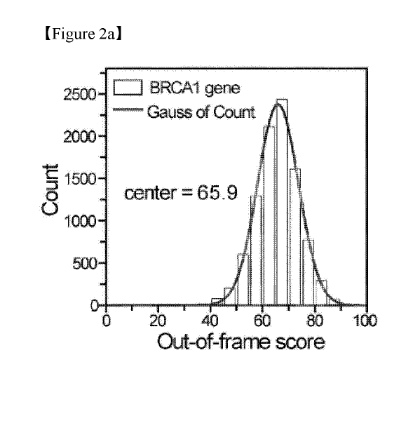

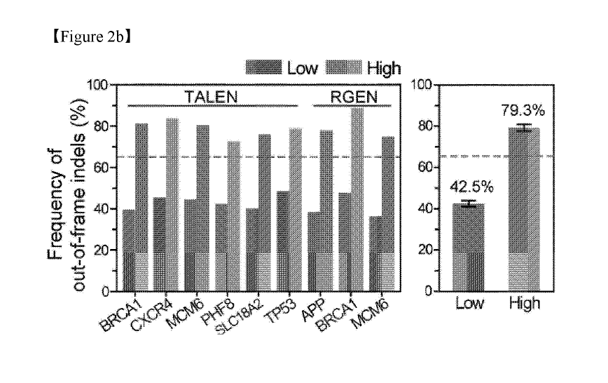

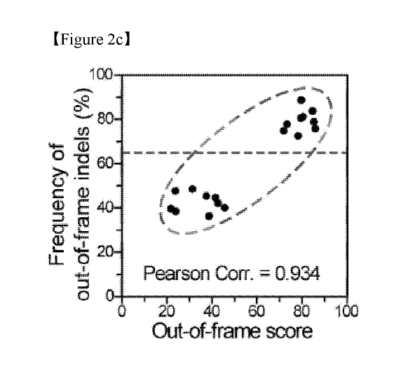

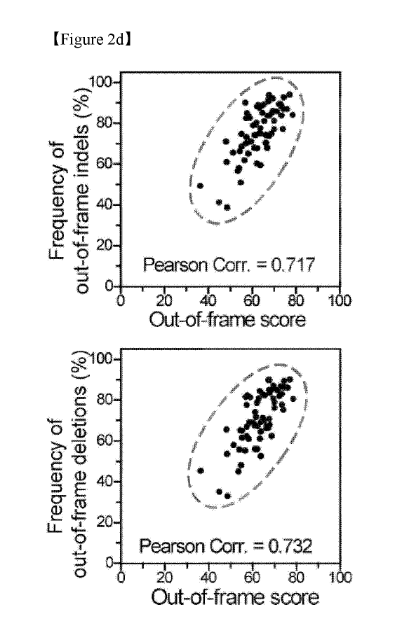

To evaluate the utility of our scoring system, two target sites, one with a high score and the other with a low score, in each of 9 human genes were chosen. To this end, all RGEN target sites (5′-X20NGG-3′, where X20 corresponds to the crRNA or sgRNA sequence and NGG is the protospacer-adjacent motif (PAM) recognized by Cas9) in the human BRCA1 gene (9,494 sites in exons and introns) were firstly identified and the microhomology score and the out-of-frame score were assigned to each target site. Interestingly, the out-of-frame scores were distributed according to a Gaussian function with a peak value at 65.9 (FIG. 2a). This is expected because two thirds of all the microhomology-associated deletions would result in frame-shift mutations. Two target sites in exons, one from the top 20% of the scores and the other from the bottom 20%, were arbitrarily chosen. Likewise, high-score sites and low-score sites in 8 other genes were chosen. A total of 6 or 12 sites were targeted by RGENs or TALENs, respectively (Table 2). Then, mutations in human cells by transfecting cells with plasmids encoding these nucleases were induced, regions containing the target sites were amplified, and the PCR amplicons were deeply sequenced to obtain the fraction of out-of-frame indels at each target site (Table 4).

TABLE 4

| | | | | | | Frequency | Frequency | | |
|---|---|---|---|---|---|---|---|---|---|
| | | | | | | of | of | | |
| | | | Number | | | out-of- | out-of- | | |
| | | | of | | | frame | frame | Micro- | Out-of- |
| Nuclease | | | sequence | Inser- | Dele- | deletions | indels | homology | frame |
| (Cell type) | Gene | Name | reads | tion | tion | (%) | (%) | score^{a} | score^{b} |
| TALEN | BRCA1 | BRCA1_l | 77583 | 795 | 32519 | 39.10479085 | 39.62392158 | 4363 | 21.77531 |
| (HEK293T) | BRCA1 | BRCA1_h | 122533 | 871 | 62077 | 81.10301121 | 81.08088489 | 3045 | 80.42693 |
| | CXCR4 | CXCR4_l | 117578 | 417 | 42130 | 45.26139826 | 45.26136207 | 3903 | 37.56086 |
| | CXCR4 | CXCR4_h | 280176 | 882 | 52068 | 83.71982103 | 83.72436317 | 4061 | 84.73282 |
| | MCM6 | MCM6_l | 191096 | 3459 | 131302 | 43.83248991 | 44.57927991 | 3759 | 41.63341 |
| | MCM6 | MCM6_h | 267702 | 941 | 19526 | 80.00247724 | 80.4623862 | 3312 | 79.56453 |
| | PHF8 | PHF8_l | 253216 | 1071 | 87348 | 41.78051364 | 42.10553931 | 4765 | 42.70724 |
| | PHF8 | PHF8_h | 264899 | 1811 | 75500 | 72.27631047 | 72.47083002 | 3267 | 78.29813 |
| | SLC18A2 | SLC18_l | 356244 | 2773 | 147564 | 39.79381922 | 40.00610221 | 4816 | 45.72259 |
| | SLC18A2 | SLC18_h | 374261 | 2427 | 98331 | 75.64093697 | 76.76827054 | 4220 | 85.92417 |
| | TP53 | TP53_l | 84253 | 342 | 15334 | 48.1871345 | 48.46955659 | 3636 | 31.33498 |
| | TP53 | TP53_h | 176325 | 1210 | 28962 | 79.16705144 | 78.8308357 | 3769 | 85.35421 |
| RGEN | APP | APP_l | 68578 | 559 | 6112 | 34.55981506 | 38.37524378 | 7565 | 23.91276 |
| (K562) | APP | APP_h | 278349 | 2952 | 23162 | 76.58807947 | 77.76956436 | 4180 | 73.37321 |
| | BRCA1 | BRCA1_l | 143960 | 10054 | 30439 | 36.66284963 | 47.56692842 | 3658 | 23.75615 |
| | BRCA1 | BRCA1_h | 102903 | 3066 | 15415 | 88.1639982 | 88.66998256 | 4432 | 79.62545 |
| | MCM6 | MCM6_l | 273431 | 3304 | 93399 | 34.19839631 | 36.18849409 | 4359 | 38.74742 |
| | MCM6 | MCM6_h | 167502 | 6026 | 14745 | 65.16221147 | 74.78114478 | 6330 | 71.87994 |

${ }^{a} Microhomoly score = Σ pattern score .$ ${}^{b} Out \text{-} of \text{-} frame = \frac{Σ pattern score of an out \text{-} of \text{-} frame deletion}{Σ pattern score} , ( \pm 30 bp between target sites )$

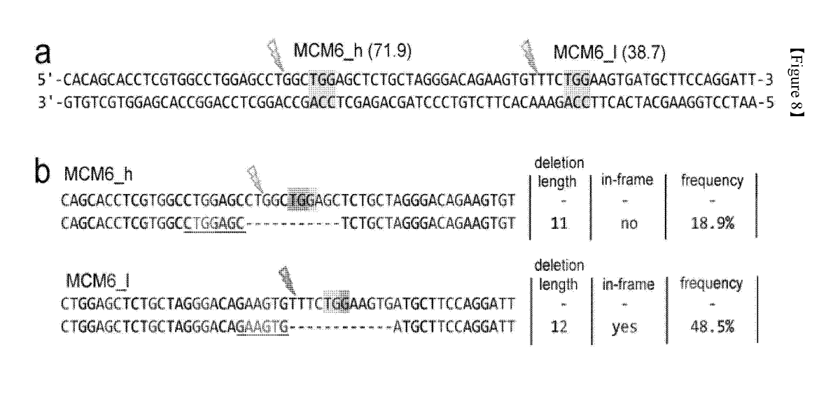

High-score sites produced out-of-frame indels much more frequently than did low-score sites in all of the 9 pairs (FIG. 2b). Thus, all 9 high-score sites produced frameshifting indels at frequencies higher than 66%, the mean value of predicted scores. In contrast, all 9 low-score sites produced out-of-frame mutations at frequencies much lower than the mean. For example, two RGENs induced out-of-frame indels at frequencies of 36.2% and 74.8% at two adjacent low-score and high-score sites, respectively, in the MCM6 gene; the sites were separated by merely 29 bp (FIG. 8), highlighting the importance of target site choice. On average, the high-score sites and low-score sites produced frameshifting indels at frequencies of 79.3% and 42.5%, respectively (Student's t-test, p<0.001). In a diploid cell or organism, the probability of obtaining null clones would be 62.8% (=0.793×0.793) and 18.1% (=0.425×0.425), respectively, strikingly similar to our two extreme-case estimations of 64% and 16% described above. As expected, the out-of-frame scores were reliable predictors of the frequencies of frameshifting indels (Pearson coefficient=0.934) (FIG. 2c). To demonstrate the usefulness of our scoring system further, we tested 68 new RGENs that target different genes in yet another human cell line, HeLa (Table 5).

TABLE 5

| | | | | | Frequency | | | |
|---|---|---|---|---|---|---|---|---|
| | | | | | of | Frequency | | |
| | | Number of | | | out-of-frame | of | Micro- | Out-of- |
| | Target site | sequence | Inser- | Dele- | deletions | out-of-frame | homology | frame |
| Gene | (5′ to 3′) | reads | tion | tion | (%) | indels (%) | score^{a} | score^{b} |
| ABL1 | TGGGGCTGGATAATGGAG | 3777 | 630 | 849 | 89.8704 | 93.712 | 5895 | 67.68447837 |
| | CGTGG | | | | | | | |
| | (SEQ ID NO: 40) | | | | | | | |
| ACK | CGGTCCAACAACGATCCC | 2374 | 306 | 1112 | 74.1007 | 79.2666 | 4429 | 61.21020546 |
| | AGAGG | | | | | | | |
| | (SEQ ID NO: 41) | | | | | | | |
| ALK | CTGTGACCACGGGACGGT | 4753 | 905 | 2248 | 66.1922 | 74.3102 | 5617 | 66.22752359 |
| | GCTGG | | | | | | | |
| | (SEQ ID NO: 42) | | | | | | | |
| ARG | TCCATCTCGCTCAGGTAC | 4316 | 985 | 2188 | 80.8044 | 86.0384 | 4220 | 69.43127962 |
| | GAGGG | | | | | | | |
| | (SEQ ID NO: 43) | | | | | | | |
| AXL | GTCCCGTGTCGGAAAGCT | 3514 | 494 | 1870 | 61.6043 | 68.5702 | 4729 | 55.25481074 |
| | GCAGG | | | | | | | |
| | (SEQ ID NO: 44) | | | | | | | |
| BLK | ACTACACCGCTATGAATG | 4121 | 1286 | 1280 | 81.4844 | 90.0624 | 4684 | 56.85311699 |
| | ATCGG | | | | | | | |
| | (SEQ ID NO: 45) | | | | | | | |
| BRK | CCCAGAGGCCCACATACT | 3380 | 913 | 1229 | 55.9805 | 74.2297 | 5984 | 61.1631016 |
| | TGGGG | | | | | | | |
| | (SEQ ID NO: 46) | | | | | | | |
| CCK4 | ACATGCCGCTATTTGAGC | 3946 | 133 | 794 | 55.9194 | 60.1942 | 4259 | 62.15073961 |
| | CACGG | | | | | | | |
| | (SEQ ID NO: 47) | | | | | | | |
| CSK | CTGACCGACCCCTAGACC | 4102 | 1053 | 1715 | 82.7405 | 88.7283 | 5058 | 64.84776592 |
| | GCAGG | | | | | | | |
| | (SEQ ID NO: 48) | | | | | | | |
| CTK | GCGGAAACACGGGACCAA | 4469 | 376 | 1571 | 78.9306 | 81.1505 | 6340 | 69.95268139 |
| | GTCGG | | | | | | | |
| | (SEQ ID NO: 49) | | | | | | | |
| DDR2 | CCCCAGTGCTCGGTTTGT | 6186 | 1082 | 3531 | 84.3104 | 87.5569 | 5379 | 63.32031976 |
| | CACGG | | | | | | | |
| | (SEQ ID NO: 50) | | | | | | | |
| EGFR | CAAAGCTGTATTTGCCCT | 4302 | 194 | 688 | 67.0058 | 73.2426 | 3892 | 57.34840699 |
| | CGGGG | | | | | | | |
| | (SEQ ID NO: 51) | | | | | | | |
| EphA1 | GCTCCAATTGGATCTACC | 3762 | 317 | 2322 | 70.801 | 73.7779 | 4049 | 67.64633243 |
| | GCGGG | | | | | | | |
| | (SEQ ID NO: 52) | | | | | | | |
| EphA10 | TGGACCGGCGCAGGTCTC | 3575 | 754 | 774 | 71.3178 | 85.0785 | 5892 | 64.69789545 |
| | CATGG | | | | | | | |
| | (SEQ ID NO: 53) | | | | | | | |
| EphA2 | AGGCTCCGAGTAGCGCAC | 3700 | 696 | 727 | 77.7166 | 88.2642 | 5328 | 73.40465465 |
| | ACTGG | | | | | | | |
| | (SEQ ID NO: 54) | | | | | | | |
| EphA3 | TTGTCGACCAGGTTTCTA | 2132 | 608 | 636 | 87.1069 | 92.0418 | 3497 | 69.48813269 |
| | CAAGG | | | | | | | |
| | (SEQ ID NO: 55) | | | | | | | |
| EphA4 | AACACCGAGATCCGGGAT | 5136 | 287 | 2520 | 85.2381 | 85.1087 | 4003 | 68.99825131 |
| | GTAGG | | | | | | | |
| | (SEQ ID NO: 56) | | | | | | | |
| EphA5 | ACTGCAGCGCCGAAGGGG | 4830 | 109 | 1800 | 67.27778 | 67.7842 | 6062 | 62.27317717 |
| | AGTGG | | | | | | | |
| | (SEQ ID NO: 57) | | | | | | | |
| EphA6 | TCTCTCAATACGAATTCT | 3660 | 344 | 1357 | 52.5424 | 59.3768 | 4342 | 63.79548595 |
| | TGAGG | | | | | | | |
| | (SEQ ID NO: 58) | | | | | | | |
| EphA7 | CACCTGGTATGTTCGTAT | 6125 | 1850 | 2738 | 89.2988 | 92.6548 | 4648 | 74.44061962 |
| | CGGG | | | | | | | |
| | (SEQ ID NO: 59) | | | | | | | |
| EphB1 | CACATGCATCCCCAACGC | 3688 | 361 | 2105 | 71.6865 | 74.2092 | 4395 | 61.592719 |
| | AGAGG | | | | | | | |
| | (SEQ ID NO: 60) | | | | | | | |
| EphB2 | GGCTACGGACCAAGTTTA | 3553 | 49 | 537 | 68.9013 | 70.9898 | 3974 | 59.33568193 |
| | TCCGG | | | | | | | |
| | (SEQ ID NO: 61) | | | | | | | |
| EphB4 | GCAGAATATTCGGACAAA | 4113 | 1337 | 1722 | 90.0697 | 93.9523 | 4455 | 77.08193042 |
| | CACGG | | | | | | | |
| | (SEQ ID NO: 62) | | | | | | | |
| EphB6 | CTTCACCCTTTACTACCG | 4867 | 472 | 2010 | 89.7512 | 90.5318 | 4798 | 67.27803251 |
| | TCAGG | | | | | | | |
| | (SEQ ID NO: 63) | | | | | | | |
| FER | AGACTGGGAATTACGGTT | 4619 | 172 | 2246 | 67.4978 | 67.9487 | 4468 | 61.01163832 |
| | ACTGG | | | | | | | |
| | (SEQ ID NO: 64) | | | | | | | |
| FES | GGAGGCCGAGCTTCGTCT | 3287 | 75 | 756 | 32.8042 | 38.7485 | 4584 | 48.58202443 |
| | ACTGG | | | | | | | |
| | (SEQ ID NO: 65) | | | | | | | |
| FGFR1 | CTCTGACTGGTTGACCGT | 4070 | 210 | 1386 | 83.4776 | 83.7719 | 4649 | 67.84254678 |
| | TCTGG | | | | | | | |
| | (SEQ ID NO: 66) | | | | | | | |
| FGFR3 | CGGCAACTACACCTGCGT | 2250 | 299 | 1171 | 65.585 | 70.9524 | 4392 | 48.13296903 |
| | CGTGG | | | | | | | |
| | (SEQ ID NO: 67) | | | | | | | |
| FGFR4 | AACTCCCATAGTGGGTCG | 6126 | 204 | 659 | 62.3672 | 70.2202 | 4744 | 57.25126476 |
| | AGAGG | | | | | | | |
| | (SEQ ID NO: 68) | | | | | | | |
| FGR | GCAGCTGTACGCCGTGGT | 4216 | 175 | 1686 | 45.255 | 49.2746 | 5234 | 36.35842568 |
| | GTCGG | | | | | | | |
| | (SEQ ID NO: 69) | | | | | | | |
| FMS | ATCTACTTGATCGAGGTT | 6805 | 467 | 2273 | 53.5416 | 60.9489 | 4919 | 48.34315918 |
| | GAGGG | | | | | | | |
| | (SEQ ID NO: 70) | | | | | | | |
| FRK | CTGGTCAGTTTGGCGAAG | 4682 | 537 | 699 | 81.9742 | 89.4013 | 4712 | 72.24108659 |
| | TATGG | | | | | | | |
| | (SEQ ID NO: 71) | | | | | | | |
| FYN | GGGACCTTGCGTACGAGA | 4055 | 130 | 1897 | 66.5788 | 67.8836 | 4443 | 66.93675445 |
| | GGAGG | | | | | | | |
| | (SEQ ID NO: 72) | | | | | | | |
| HCK | TGTCGCCCGCGTTGACTC | 4822 | 200 | 420 | 86.6667 | 89.5161 | 3736 | 72.88543897 |
| | TCTGG | | | | | | | |
| | (SEQ ID NO: 73) | | | | | | | |
| HER2/ | AGCTGGCGCCGAATGTAT | 4921 | 121 | 1935 | 76.1757 | 77.0914 | 5021 | 69.94622585 |
| ErbB2 | ACCGG | | | | | | | |
| | (SEQ ID NO: 74) | | | | | | | |
| IGF1R | TCAGTACGCCGTTTACGT | 4857 | 1117 | 2543 | 65.0806 | 74.7268 | 3991 | 55.14908544 |
| | CAAGG | | | | | | | |
| | (SEQ ID NO: 75) | | | | | | | |
| INSR | GAGAATTGCTCTGTCATC | 5838 | 924 | 920 | 84.8913 | 91.5944 | 4280 | 67.52336449 |
| | GAAGG | | | | | | | |
| | (SEQ ID NO: 76) | | | | | | | |
| ITK | AAGCGGACTTTAAAGTTC | 5075 | 125 | 472 | 80.5085 | 84.0871 | 4851 | 78.51989281 |
| | GAGGG | | | | | | | |
| | (SEQ ID NO: 77) | | | | | | | |
| JAK2 | AGCAACAGAGCCTATCGG | 4060 | 254 | 1473 | 67.2098 | 70.3532 | 4379 | 66.31651062 |
| | CATGG | | | | | | | |
| | (SEQ ID NO: 78) | | | | | | | |
| JAK3 | CTGGAAAGTCGCAGAAGG | 3349 | 102 | 574 | 86.2369 | 86.9822 | 4551 | 74.29136454 |
| | GCTGG | | | | | | | |
| | (SEQ ID NO: 79) | | | | | | | |
| KDR | TCCAGTTTCCTGTGATC | 5604 | 988 | 1684 | 61.1045 | 75 | 3825 | 63.34640523 |
| | GTGGG | | | | | | | |
| | (SEQ ID NO: 80) | | | | | | | |
| KIT | TATTCTCATTCGTTTCAT | 5126 | 428 | 1633 | 55.2358 | 61.8147 | 5110 | 56.53620352 |
| | CCAGG | | | | | | | |
| | (SEQ ID NO: 81) | | | | | | | |
| LCK | GAGCCTTCGTAGGTAACC | 3159 | 141 | 680 | 82.9412 | 83.8002 | 4884 | 73.42342342 |
| | AGTGG | | | | | | | |
| | (SEQ ID NO: 82) | | | | | | | |
| LMR1 | GCCACCCGTCGACGTCCC | 3363 | 236 | 1810 | 78.5083 | 80.2053 | 8541 | 61.97166608 |
| | CTGGG | | | | | | | |
| | (SEQ ID NO: 83) | | | | | | | |
| LMR2 | GCTCAGGAGCGTTGAACT | 4756 | 1648 | 1807 | 68.9541 | 83.3864 | 4369 | 58.41153582 |
| | TGAGG | | | | | | | |
| | (SEQ ID NO: 84) | | | | | | | |
| LTK | TGGCTCCAAGATACTAGG | 4131 | 172 | 1195 | 82.3431 | 80.9802 | 5454 | 85.52988632 |
| | CGGGG | | | | | | | |
| | (SEQ ID NO: 85) | | | | | | | |
| MER | CTATTCCCGGGACCTTTT | 2890 | 135 | 1320 | 81.3636 | 82.6804 | 5269 | 58.94856709 |
| | CCAGG | | | | | | | |
| | (SEQ ID NO: 86) | | | | | | | |
| MUSK | GCATAGCTACCAATAAGC | 4871 | 154 | 2709 | 65.2639 | 66.2592 | 4309 | 54.42097935 |
| | ATGGG | | | | | | | |
| | (SEQ ID NO: 87) | | | | | | | |
| PDGFRa | CAGCCTAAGACCAGGAAC | 4452 | 353 | 2708 | 84.8227 | 85.7563 | 5043 | 71.30676185 |
| | GCCGG | | | | | | | |
| | (SEQ ID NO: 88) | | | | | | | |
| PDGFRb | AGGGAACGTAGTTATCGT | 3996 | 149 | 2407 | 55.7541 | 57.903 | 4091 | 53.99657785 |
| | AAGGG | | | | | | | |
| | (SEQ ID NO: 89) | | | | | | | |
| PYK2 | GGTCCTGAATCGTATTCT | 4180 | 695 | 1995 | 77.594 | 82.3792 | 3720 | 57.31182796 |
| | TGGGG | | | | | | | |
| | (SEQ ID NO: 90) | | | | | | | |
| RET | TGCTGGGTGATGCGGCCG | 3179 | 305 | 1027 | 69.2308 | 75.0751 | 5776 | 63.78116348 |
| | GTGGG | | | | | | | |
| | (SEQ ID NO: 91) | | | | | | | |
| RON | GTCATCGGGCCGGTTATG | 3350 | 1133 | 1326 | 78.9593 | 88.2066 | 6432 | 62.18905473 |
| | GTGGG | | | | | | | |
| | (SEQ ID NO: 92) | | | | | | | |
| ROR1 | GCCATAGATGGTGGACCG | 5172 | 571 | 2748 | 82.2416 | 84.9654 | 6204 | 57.62411348 |
| | AAAGG | | | | | | | |
| | (SEQ ID NO: 93) | | | | | | | |
| ROS | TGAGGTGCACTAATAGAG | 4098 | 503 | 1663 | 44.979 | 56.5559 | 3834 | 53.5732916 |
| | GGTGG | | | | | | | |
| | (SEQ ID NO: 94) | | | | | | | |
| RYK | TATTGCCTTACATGAATT | 6079 | 753 | 2584 | 67.8406 | 74.1984 | 4018 | 67.86958686 |
| | GGGGG | | | | | | | |
| | (SEQ ID NO: 95) | | | | | | | |
| SRC | GTCTGACTTCGACAACGC | 4141 | 232 | 1700 | 35.0588 | 41.2526 | 4157 | 44.84002887 |
| | CAAGG | | | | | | | |
| | (SEQ ID NO: 96) | | | | | | | |
| SRM | CCACACTCCGAATTCGCC | 1423 | 73 | 722 | 75.2078 | 77.1069 | 4392 | 73.97540984 |
| | CTTGG | | | | | | | |
| | (SEQ ID NO: 97) | | | | | | | |
| SYK | GGTGATGTTGCCGAAAAA | 3825 | 368 | 1474 | 57.9376 | 65.5809 | 4424 | 51.37854268 |
| | GAAGG | | | | | | | |
| | (SEQ ID NO: 98) | | | | | | | |
| TIE1 | CGCCTGTGGGACGGGACA | 2050 | 437 | 657 | 64.5358 | 77.5137 | 9164 | 63.74945439 |
| | CGGGG | | | | | | | |
| | (SEQ ID NO: 99) | | | | | | | |
| TIE2 | CAGAGTTCATATTCTGTC | 5063 | 1238 | 2267 | 68.8134 | 75.9444 | 4027 | 80.44201639 |
| | CGAGG | | | | | | | |
| | (SEP ID NO: 100) | | | | | | | |
| TNK1 | GCAGTAGGTTGCGCGTAG | 3497 | 1307 | 725 | 69.931 | 89.2224 | 7094 | 65.21003665 |
| | CGAGG | | | | | | | |
| | (SEQ ID NO: 101) | | | | | | | |
| TRKB | GCCGTGGTACTCCGTGTG | 4525 | 1080 | 1973 | 62.3923 | 74.8772 | 3748 | 68.72998933 |
| | ATTGG | | | | | | | |
| | (SEQ ID NO: 102) | | | | | | | |
| TRKC | CATCAGCGTTGATGCAGT | 5151 | 83 | 876 | 48.0594 | 50.9906 | 5474 | 54.74972598 |
| | AGAGG | | | | | | | |
| | (SEQ ID NO: 103) | | | | | | | |
| TXK | GTTGTTTACCAGCCACAG | 5371 | 1954 | 1682 | 66.4685 | 83.8284 | 4931 | 66.98438451 |
| | CTGGG | | | | | | | |
| | (SEQ ID NO: 104) | | | | | | | |
| TYK2 | GAACCGGCTGTGTACCGT | 4569 | 87 | 466 | 86.0515 | 86.9801 | 5638 | 75.8957077 |
| | TGTGG | | | | | | | |
| | (SEQ ID NO: 105) | | | | | | | |
| TYRO3 | GGCCACACTAGCGTTGCT | 4466 | 345 | 2254 | 60.9583 | 65.0635 | 4665 | 58.17792069 |
| | GCTGG | | | | | | | |
| | (SEQ ID NO: 106) | | | | | | | |
| YES | TCAGGTCTGTATTTAATG | 5584 | 1157 | 1364 | 80.9384 | 88.8933 | 4727 | 62.83054792 |
| | GCTGG | | | | | | | |
| | (SEQ ID NO: 107) | | | | | | | |

${ }^{a} Microhomoly score = Σ pattern score .$ ${}^{b} Out \text{-} of \text{-} frame = \frac{Σ pattern score of an out \text{-} of \text{-} frame deletion}{Σ pattern score} , ( \pm 35 bp between target sites )$

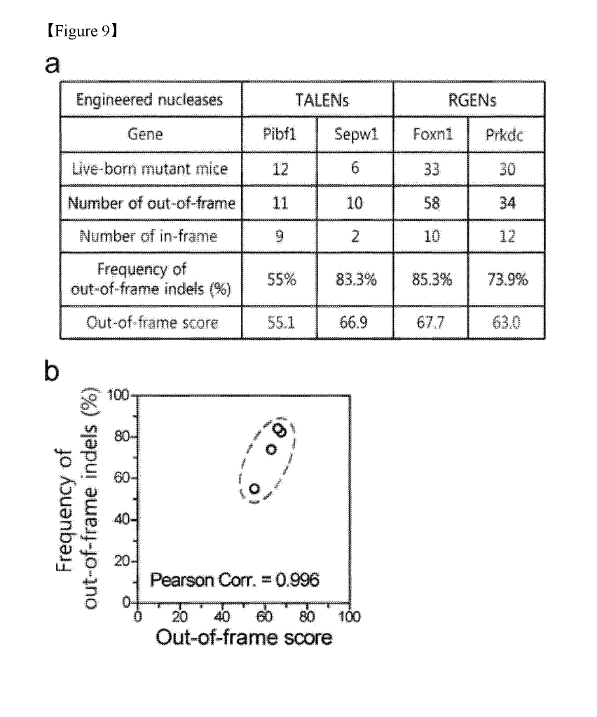

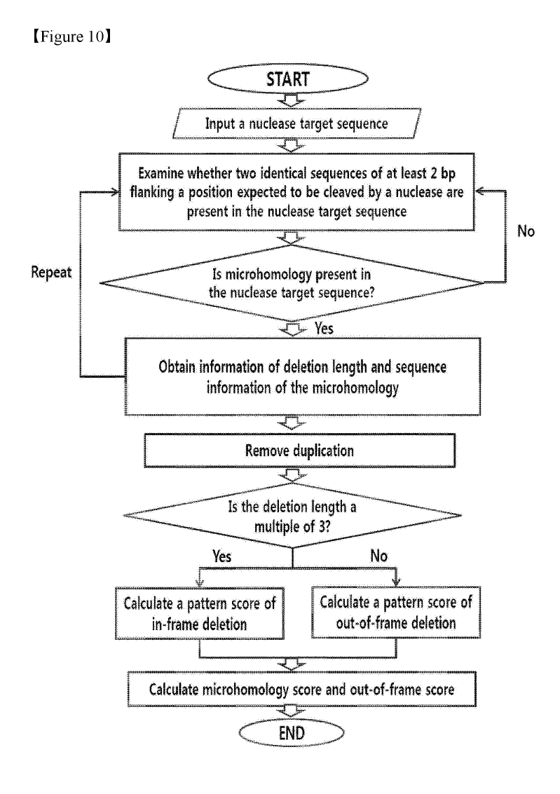

Again, out-of-frame scores correlated well with the frequencies of frame shifting indels or deletions (Pearson coefficient=0.717 or 0.732, respectively) (FIG. 2d). The frequencies of out-of-frame indels ranged from 38.7% to 94.0%. In a diploid human cell, the probability of obtaining null clones would range from 15.0% (=0.387×0.387) to 88.4%, a 5.9-fold difference between the extreme cases. Most cancer cell lines including HeLa are multi-ploid (>3n), making it more important to choose high-score sites. It is expected that the scoring system would work even better for TALENs because TALENs induce microhomology-independent insertions much less frequently than do RGENs, as shown above. In addition, it was analyzed that the genotypes of 81 live-born mice carrying mutations that had been produced via TALENs or RGENs in our previous studies (Sung, Y. H. et al. Genome research 24, 125-131 (2014); Sung, Y. H. et al. Nature biotechnology 31, 23-24 (2013)). The frequencies of out-of-frame deletions correlated well with predicted scores (Pearson coefficient=0.996) (FIG. 9).

Those skilled in the art will appreciate that the conceptions and specific embodiments disclosed in the foregoing description may be readily utilized as a basis for modifying or designing other embodiments for carrying out the same purposes of the present invention. Those skilled in the art will also appreciate that such equivalent embodiments do not depart from the spirit and scope of the invention as set forth in the appended Claims.

1. A method of selecting a nuclease target sequence for gene knockout, comprising:
(a) providing a nuclease target sequence candidate;
(b) collecting information of microhomology present in the nuclease target sequence candidate; and
(c) predicting frequency of microhomology-associated out-of-frame deletion of the nuclease target sequence candidate based on the information of microhomology collected in step (b).

2. The method according to claim 1, further comprising a step of comparing the frequency of microhomology-associated out-of-frame deletion predicted in step (c) with frequency of microhomology-associated out-of-frame deletion of other nuclease target sequence candidate.

3. The method according to claim 1, wherein the information of microhomology comprises a size of microhomology sequence, a distance between two microhomology sequences, and sequence information of the microhomology sequence.

4. The method according to claim 1, wherein the nuclease is selected from the group consisting of zinc finger nucleases (ZFNs), transcription-activator-like effector nucleases (TALENs), and clustered regularly interspaced short palindromic repeats (CRISPR)-RNA-guided engineered nucleases (RGENs).

5. The method according to claim 1, wherein step (c) comprises:
calculating a pattern score, which is a score assigned to an expected deletion pattern of each of microhomologies present in the given nuclease target sequence candidate; and
calculating (i) a microhomology score, which is a sum of the pattern scores of all microhomologies in the given nuclease target sequence candidate and (ii) a out-of-frame score, which is a ratio of a score which is a sum of the pattern scores of microhomologies associated with out-of-frame deletion to the microhomology score, based on the calculated pattern score.

6. The method according to claim 1, wherein the method comprises:
i) providing a nuclease target sequence candidate;
ii) examining, in the given nuclease target sequence, whether two identical sequences of at least 2 bp flanking a position expected to be cleaved by a nuclease are present in the target sequence to identify the presence of microhomology;
iii) obtaining information of microhomology, when the microhomology is present in the target sequence, and repeating steps ii) and iii) one or more times;
iv) calculating a pattern score, which is a score assigned to an expected deletion pattern of each of microhomologies present in the given nuclease target sequence candidate; and
v) calculating (i) a microhomology score, which is a sum of the pattern scores of all microhomologies in the given nuclease target sequence candidate and (ii) a out-of-frame score, which is a ratio of a score which is a sum of the pattern scores of microhomologies associated with out-of-frame deletion to the microhomology score.

7. The method according to claim 5, wherein the pattern score is calculated using Equation 1:
Pattern score=SXexp(−Δ/W_{length}), [Equation 1]
wherein,
S is a microhomology index that corresponds to the size and base pairing energy of the microhomology sequence;
Δ is a distance between initiation sites located at 5′ position of each microhomology sequence or a distance between terminal sites located at 3′ position of each microhomology sequence of the two microhomology sequences (deletion length); and
W_{length} is a weight factor on a distance between the microhomology sequences.

8. The method according to claim 5, wherein the microhomology score is calculated using Equation 2, and the out-of-frame score is calculated using Equation 3:
Microhomology score=Σ pattern score, [Equation 2]
wherein the microhomology score is a sum of pattern scores of the obtained all microhomologies;
Out-of-frame score=Σ pattern score of out-of-frame deletion/Microhomology score(Σ pattern score), [Equation 3]
wherein Σ pattern score of out-of-frame deletion is a sum of pattern scores of relevant microhomologies whose deletion length is not a multiple of 3.

9. The method according to claim 7, wherein, in Equation 1,
a) the microhomology index (S) is calculated by Equation 4 below; and
b) W_{length} is 20:
Microhomology index=(number of G and C in the microhomology sequence)*2+(number of A and T bases in the microhomology sequence). [Equation 4]

10. A method of providing information for selecting a sequence having high efficiency of out-of-frame deletion by a nuclease, comprising:
(a) providing a nuclease target sequence candidate;
(b) collecting information of microhomology present in the nuclease target sequence candidate; and
(c) predicting frequency of microhomology-associated out-of-frame deletion of the nuclease target sequence candidate based on the information of microhomology collected in step (b).

11. A computer program capable of performing a method according to claim 1.

12. A computer-readable recording medium in which the program according to claim 11 is recorded.

13. The method according to claim 6, wherein the pattern score is calculated using Equation 1:
Pattern score=SXexp(−Δ/W_{length}), [Equation 1]
wherein,
S is a microhomology index that corresponds to the size and base pairing energy of the microhomology sequence;
Δ is a distance between initiation sites located at 5′ position of each microhomology sequence or a distance between terminal sites located at 3′ position of each microhomology sequence of the two microhomology sequences (deletion length); and
W_{length} is a weight factor on a distance between the microhomology sequences.

14. The method according to claim 6, wherein the microhomology score is calculated using Equation 2, and the out-of-frame score is calculated using Equation 3:
Microhomology score=Σ pattern score, [Equation 2]
wherein the microhomology score is a sum of pattern scores of the obtained all microhomologies;

15. The method according to claim 6, wherein the microhomology score is calculated using Equation 2, and the out-of-frame score is calculated using Equation 3:
Microhomology score=Σ pattern score, [Equation 2]
wherein the microhomology score is a sum of pattern scores of the obtained all microhomologies;
Out-of-frame score=Σ pattern score of out-of-frame deletion/Microhomology score(Σ pattern score), [Equation 3]
wherein Σ pattern score of out-of-frame deletion is a sum of pattern scores of relevant microhomologies whose deletion length is not a multiple of 3.

16. The method according to claim 13, wherein, in Equation 1,
a) the microhomology index (S) is calculated by Equation 4 below; and
b) W_{length} is 20:
Microhomology index=(number of G and C in the microhomology sequence)*2+(number of A and T bases in the microhomology sequence). [Equation 4]
